(19) United States
(12) Patent Application Publication
(10) Pub. No.: US 2026/0115657 A1
(43) Pub. Date: Apr. 30, 2026

(54) CARBON DIOXIDE CAPTURE USING DIFFERENT GAS INPUT STREAMS

(71) Applicant: Eleryc, Inc., Campbell, CA (US)

(72) Inventors: Ian Robinson, San Jose, CA (US); David Koshy, San Mateo, CA (US); Kyle Weldon Self, San Jose, CA (US)

(73) Assignee: Eleryc, Inc., Campbell, CA (US)

(21) Appl. No.: 19/367,629

(22) Filed: Oct. 23, 2025

Related U.S. Application Data
(60) Provisional application No. 63/711,680, filed on Oct. 24, 2024.

(51) Int. Cl. B01D 53/62; B01D 53/14; B01D 53/75; B01D 53/78; B01D 53/96

(52) U.S. Cl. CPC B01D 53/62; B01D 53/1406; B01D 53/1425; B01D 53/1475; B01D 53/1493; B01D 53/75; B01D 53/78; B01D 53/965; B01D 2251/304; B01D 2251/306; B01D 2251/604; B01D 2257/504; B01D 2258/0283; B01D 2258/06

(57) ABSTRACT

Systems and methods for capturing carbon dioxide from multiple different sources at least in part via the electrochemical production of acids and/or bases are generally described. The carbon dioxide may be captured at least in part via exposure of a first input gas stream from a first source to a capture agent (e.g., a liquid solution comprising electrogenerated basic species) to generate carbonate anions, and then subsequent conversion of at least some of the carbonate anions to bicarbonate anions via capture of additional carbon dioxide from a second input gas stream from a second, different source. The first source may be ambient air (e.g., for a direct air capture process), while the second source may be a point source of carbon dioxide (e.g., industrial effluent).

### RELATED APPLICATIONS

This application claims priority under 35 U.S.C. § 119 (e) to U.S. Provisional Patent Application No. 63/711,680, filed Oct. 24, 2024, and entitled “Carbon Dioxide Capture Using Different Gas Input Streams,” which is incorporated herein by reference in its entirety for all purposes.

### TECHNICAL FIELD

Systems and methods for capturing carbon dioxide at least in part via the electrochemical production of acids and/or bases are generally described.

### BACKGROUND

Capturing and, in some cases, releasing carbon dioxide can be an important process (e.g., for carbon mitigation). Accordingly, improved methods and systems for capturing and, in some cases, releasing carbon dioxide are desirable.

### SUMMARY

Systems and methods for capturing carbon dioxide from multiple different sources at least in part via the electrochemical production of acids and/or bases are generally described. The subject matter of the present invention involves, in some cases, interrelated products, alternative solutions to a particular problem, and/or a plurality of different uses of one or more systems and/or articles.

In one aspect, methods for at least partially separating carbon dioxide from a gas stream are provided. In some embodiments, the method comprises transporting an aqueous input stream to an electrochemical cell, applying an electrical potential difference across the electrochemical cell and performing one or more reactions involving at least one component of the aqueous input stream to produce a base-rich product solution comprising electrogenerated basic species; exposing at least some of the electrogenerated basic species to carbon dioxide from a first input gas stream, at least a portion of the first input gas stream being from a first source, to generate: a first carbon dioxide-lean output gas stream having a lower concentration of carbon dioxide than the first input gas stream; and a first capture stream comprising dissolved carbonate anions formed from the carbon dioxide from the first input gas stream; and exposing at least a portion of the first capture stream to carbon dioxide from a second input gas stream, at least a portion of the second input gas stream being from a second, different source, the second input gas stream comprising carbon dioxide at a higher concentration and/or partial pressure than the first input gas stream to generate: a second carbon dioxide-lean output gas stream having a lower concentration of carbon dioxide than the second input gas stream; and a second capture stream comprising dissolved bicarbonate anions, at least some of which are generated from carbonate anions from the first capture stream by a reaction resulting from exposure of the at least a portion of the first capture stream to carbon dioxide from the second input gas stream.

In another aspect, systems for at least partially separating carbon dioxide from a gas stream are provided. In some embodiments, the system is configured to perform a method of this disclosure.

In another aspect, systems for at least partially separating carbon dioxide from a gas stream are provided. In some embodiments, the system comprises an electrochemical assembly comprising an electrochemical cell; an electrochemical assembly liquid inlet configured to receive an aqueous input stream; and an electrochemical assembly liquid outlet configured to output a solution comprising a product species generated at least in part by one or more reactions performed in the electrochemical assembly; a first gas-liquid contact vessel comprising: a first contact vessel gas inlet configured to receive a first input gas stream comprising carbon dioxide from a first source; a first contact vessel liquid inlet fluidically connected to the electrochemical assembly liquid outlet; a first contact vessel gas outlet; and a first contact vessel liquid outlet; and a second gas-liquid contact vessel comprising: a second contact vessel gas inlet configured to receive a second input gas stream comprising carbon dioxide from a second source that is different than the first source; a second contact vessel liquid inlet fluidically connected to the first contact vessel liquid outlet; a second contact vessel gas outlet; and a second contact vessel liquid outlet. In some embodiments, the system is an industrial-scale system for at least partially separating carbon dioxide from a gas stream.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic diagram of an example of a system for at least partially separating carbon dioxide from at least two different gas streams;

FIG. 1B shows a schematic diagram of an example of a system for at least partially separating carbon dioxide from at least three different gas streams;

FIG. 2A shows a schematic cross-sectional diagram of an electrochemical cell in which an aqueous input stream is transported to a catholyte chamber, according to some embodiments;

FIG. 2B shows a schematic cross-sectional diagram of an electrochemical cell in which an aqueous input stream is transported to an anolyte chamber, according to some embodiments;

FIG. 2C shows a schematic cross-sectional diagram of an electrochemical cell in which an aqueous input stream is transported to an electrolyte chamber, according to some embodiments;

FIG. 2D shows a schematic cross-sectional diagram of an electrochemical cell configured as an electrodialysis cell and comprising a bipolar membrane, according to some embodiments;

FIG. 2E shows a schematic cross-sectional diagram of an electrochemical cell configured as an electrodialysis cell and comprising a bipolar membrane, according to some embodiments;

FIG. 3A shows a schematic diagram of an example of a system for at least partially separating carbon dioxide from at least two different gas streams and then releasing at least some of the carbon dioxide, according to some embodiments;

FIG. 3B shows a schematic diagram of an example of a system for at least partially separating carbon dioxide from at least two different gas streams and then releasing at least some of the carbon dioxide, according to some embodiments;

FIG. 3C shows a schematic diagram of an example of a system for at least partially separating carbon dioxide from at least three different gas streams and then releasing at least some of the carbon dioxide, according to some embodiments;

FIGS. 4A-4B show schematic diagrams of examples of a system for at least partially separating carbon dioxide from at least two different gas streams, the system including at least one bypass stream, according to some embodiments;

FIG. 4C shows a schematic diagram of an example of a system for at least partially separating carbon dioxide from at least two different gas streams, the system including at least one product solution control valve, according to some embodiments;

FIG. 4D shows a schematic diagrams of an example of a system for at least partially separating carbon dioxide from at least two different gas streams, the system including at least one product solution control valve and at least one bypass stream control valve, according to some embodiments;

FIG. 5 shows schematic diagram of an example of a system for at least partially separating carbon dioxide from at least two different gas streams and then releasing at least some of the carbon dioxide, according to some embodiments; and

FIG. 6 shows a schematic diagram of an example of a system for at least partially separating carbon dioxide from at least two different gas streams.

### DETAILED DESCRIPTION

Systems and methods for capturing carbon dioxide from multiple different sources at least in part via the electrochemical production of acids and/or bases are generally described. The carbon dioxide may be captured at least in part via exposure of a first input gas stream from a first source to a capture agent (e.g., a liquid solution comprising electrogenerated basic species) to generate carbonate anions, and then subsequent conversion of at least some of the carbonate anions to bicarbonate anions via capture of additional carbon dioxide from a second input gas stream from a second, different source. The first source may be ambient air (e.g., for a direct air capture process), while the second source may be a point source of carbon dioxide (e.g., industrial effluent). The production of a relatively high amount of bicarbonate anions from an electrochemically-mediated capture process may improve the efficiency of the overall process, e.g., in terms of carbon dioxide captured per energetic input and/or capture species created. In some embodiments, at least some captured carbon dioxide is subsequently released. The release may be induced at least in part from exposure of the captured carbon dioxide to protic species. The protic species may be generated as part of the same electrochemical process that generates at least part of the capture agent.

Capture of carbon dioxide from a relatively dilute stream such as via direct air capture of CO₂ (DAC) is a promising method for reducing carbon dioxide levels in the atmosphere. When capturing CO₂ from the atmosphere, the low partial pressure of CO₂ typically requires the use of a solution with a strong binding affinity for CO₂, such as caustic solution (e.g., sodium hydroxide, such as aqueous sodium hydroxide), to maximize mass transfer rates. In some instances, strong caustic solution is used. In the process of capture with caustic solutions, two reactions with hydroxide ions (OH⁻) occur sequentially:

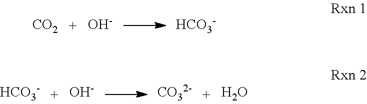

Reaction 1, the conversion of CO₂ to bicarbonate (HCO₃⁻), is typically rate-limiting while the subsequent deprotonation to carbonate

$$( {CO}_{3}^{2 -} )$$

happens very quickly. Thus, if sufficient CO₂ is provided to the system, the caustic solution may react entirely to completion (perform Reactions 1 and 2), that is, until hydroxide ions are depleted. Once the hydroxide ions are depleted, additional capture may occur via the reaction of CO₂ with the carbonate ions in solution:

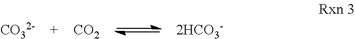

The equilibrium sign in Reaction 3 indicates that the reaction can proceed in either direction depending on the reaction conditions and the activities of the reactants and products. Of particular interest in this case is the fact that the degree to which the reaction can proceed to bicarbonate is dependent on the fugacity of the vapor phase CO₂. Thus, after completion of the capture process, a mixture of carbonate and bicarbonate is produced. The fraction of captured carbon in the form of bicarbonate versus in the form of carbonate (the de minimis fraction of the solution's CO₂ content in the form of carbonic acid can be ignored in these cases) is a relevant parameter to evaluate the efficiency of a capture process as shown in the following equation (with molecular formulas representing the total molar amounts of each molecule):

$$\frac{{OH}^{-}}{{CO}_{2}} = 1 + \frac{{CO}_{3}^{2 -}}{{CO}_{3}^{2 -} + {HCO}_{3}^{-}} \qquad Rxn 4$$

The “hydroxide efficiency number”, OH⁻/CO₂, can vary between 1 and 2, where an efficiency of 1, the desirable case, requires full conversion to bicarbonate, and an efficiency of 2 is conversion exclusively to carbonate.

The economic viability of a given dilute carbon dioxide source capture process such as a DAC process may be significantly improved by increasing the bicarbonate fraction in the capture solution due to reduced costs for caustic production/regeneration. However, the slow kinetics and unfavorable thermodynamics of reaction 3 may make it very challenging to improve the hydroxide efficiency by producing bicarbonate in most DAC systems.

DAC processes may be constrained to a hydroxide efficiency of no less than about 1.8 because the low partial pressure of CO₂ (thermodynamically the fugacity) in the atmosphere is insufficient to drive the additional conversion of carbonate to bicarbonate as shown above in Reaction 3. Typical point sources of CO₂ have partial pressures of CO₂ on the order of 0.1 bar. For example, the exhaust gas from a natural gas combined cycle (NGCC) power plant contains around 4% CO₂ (molar basis) and a cement kiln contains CO₂ concentrations that can exceed 30% (molar basis). Cases incorporating capture from these sources can approach or reach hydroxide efficiencies of 1.0.

Certain aspects of this disclosure describes the implementation of a combined source capture system (e.g., a combined DAC-point source capture system) to improve the overall hydroxide efficiency. Due to the higher CO₂ concentration in point source emissions (from fossil fuel power plants, steel, cement, aluminum, or other industrial processes), Reaction 3 is driven by both kinetics and thermodynamics towards completion. Importantly, this invention, in accordance with some embodiments, employs an electrochemical caustic regeneration system which allows flexible tandem DAC+point source capture because CO₂ release can be performed identically by addition of acid equivalents produced in the electrochemical cell.

It is believed that this electrochemical combined source process described in this disclosure is particularly advantageously implemented in this tandem fashion. It is believed that other approaches such as solid sorbent process have no ability to produce bicarbonate as they function based on adsorption of molecular CO₂ onto porous materials. It is further believed that other liquid caustic approaches that use a solid, non-electrochemical, cycling method like reversibly producing calcium carbonate, CaCO₃, cannot benefit because calcium bicarbonate, CaHCO₃ is not a known chemical compound.

It is further believed that combining capture from a relatively dilute input gas stream (e.g., for DAC) and a relatively concentrated input gas stream (e.g., for point source capture) brings both operational advantages (lower energy per unit CO₂ as discussed above), and, in some instances, improves the equipment/capital cost utilization (more CO₂ captured per dollar invested into equipment).

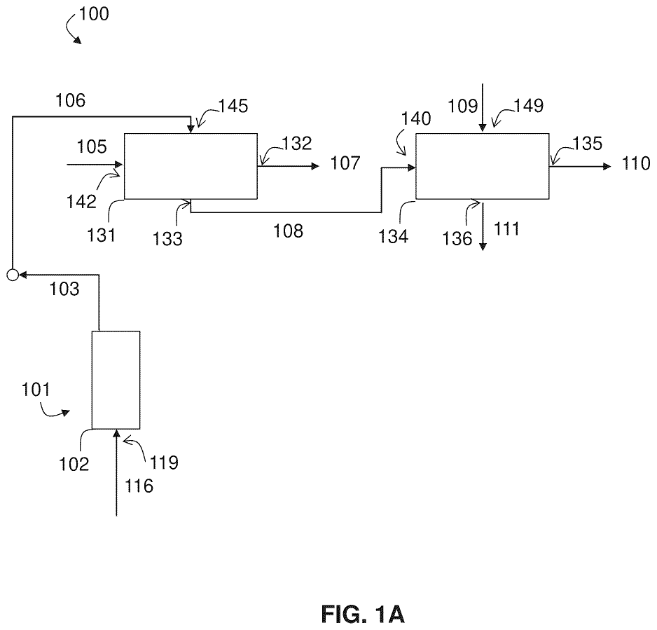

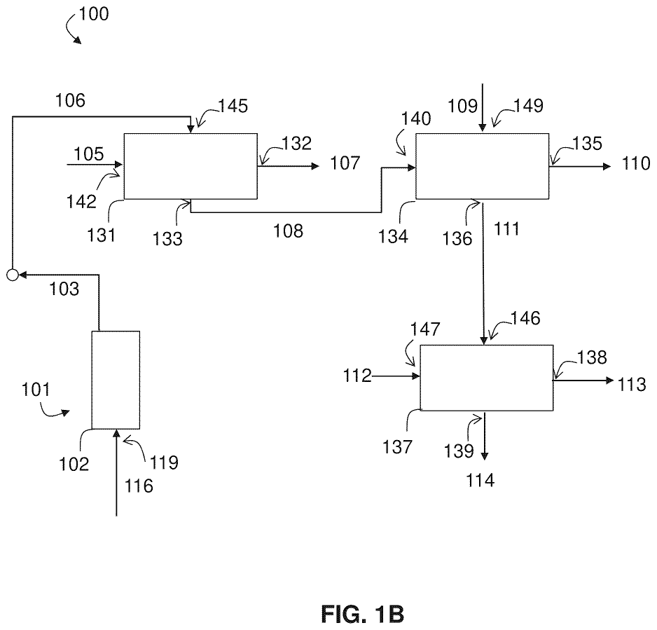

Certain aspects are directed to systems and methods for at least partially separating carbon dioxide from a gas stream. FIGS. 1A-1B and 3A-4D show schematic block diagrams of system 100, which may be employed to perform such a separation in accordance with some embodiments. In some embodiments, the system for at least partially separating carbon dioxide from a gas stream is an industrial-scale system.

As noted above, in some embodiments, an aqueous input stream is transported to an electrochemical cell. The electrochemical cell may be part of an electrochemical assembly. For example, in FIG. 1A, aqueous input stream 116 is transported to an inlet of electrochemical assembly 101 of system 100, which may include electrochemical cell 102, as discussed below. The aqueous input stream may be sourced and/or derived from any of a variety of streams, such as a brine, industrial effluent, streams from salt flats, streams rich in alkaline and/or alkali minerals (e.g., containing sulfides, sulfates, phosphates, nitrates, and/or chlorides), seawater, and/or wastewater. However, in some embodiments, the aqueous input stream is formulated for the purpose of generating base-rich and/or proton-rich product solutions (e.g., base-rich and/or proton-rich product streams) at least some of which may be suitable for participating in capture and/or release of carbon dioxide.

The aqueous input stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the aqueous input stream.

The aqueous input stream may include a relatively high concentration of dissolved salt. When a salt is dissolved, its constituents (e.g., a cation and an anion) may each be solvated (e.g., by solvent molecules such as water molecules) such that at least some of the constituents are no longer ionically bonded to each other. Accordingly, when referring to a dissolved or aqueous salt, the reference corresponds to the collection of dissolved constituents. The salt may promote relatively high conductivity within the electrochemical cell (e.g., by promoting charge neutrality as electrochemical reactions occur at and/or near electrode surfaces). Alternatively or additionally, the salt may promote high conductivity within the electrochemical cell by promoting charge transport (e.g., by promoting ion transport).

In some embodiments, the aqueous input stream comprises dissolved cations. Any of a variety of cations may be present. The cations may comprise monovalent cations (carrying a single positive charge). In some embodiments, the cations comprise metal cations. For example, the metal cations may comprise alkali metal cations. As a more specific example, the metal cations comprise sodium ions (Na⁺), lithium (Li⁺) ions, and/or potassium ions (K⁺). In some embodiments, the cations comprise ammonium cations (e.g., NH₄⁺ or a derivative thereof such as an alkylammonium). In some embodiments, the metal cations are spectator ions with respect to the chemistries employed by the electrochemical assembly and/or other reactions performed in the methods and systems of this disclosure.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %) or all of the cations in the aqueous electrolysis input stream are alkali metal cations.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %) or all of the cations in the aqueous input stream are lithium ions, sodium ions, and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %) or all of the cations in the aqueous input stream are sodium ions and/or potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %) or all of the cations in the aqueous input stream are sodium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %) or all of the cations in the aqueous input stream are potassium ions.

In some embodiments, some (e.g., at least 0.1 mol %, at least 0.2 mol %, at least 0.3 mol %, at least 1 mol %, at least 10 mol %, at least 20 mol %, at least 50 mol %, at least 75 mol %, at least 95 mol %, at least 98 mol %, at least 99 mol % at least 99.9 mol %, at least 99.99 mol %) or all of the cations in the aqueous input stream are lithium ions.

As noted above, the cations may be present in the aqueous input stream at a relatively high concentration. In some embodiments, the dissolved cations are present in the aqueous input stream at a concentration of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible. It has been observed that, in some embodiments, a concentration of the cations of greater than or equal to 1 M and less than or equal to 6 M can contribute to desirable conductivity when operating the electrochemical cell.

In some embodiments, the aqueous input stream comprises dissolved anions. Any of a variety of anions may be present. In some embodiments, at least some of the anions are non-hydroxide anions. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates, nitrites, perchlorates, and/or hydrogen sulfate anions (HSO₄⁻). In some embodiments, the anions comprise oxyanions. In some embodiments, the anions comprise divalent ions (carrying a charge of −2). For example, the anions may comprise sulfate ions (SO₄²⁻). In some embodiments, the anions comprise oxyanions. In some embodiments, the anions comprise trivalent anions (carrying a charge of −3), such as orthophosphate anions (PO₄³⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄⁻)). In some embodiments, the anions comprise borate ions (e.g., orthoborate ions (BO₃³⁻), tetrahydroxyborates (B(OH⁻)₄⁻), tetraborates (B₄O₇²⁻), and/or polyborates). In some embodiments, the anions include the conjugate base of an organic acid (e.g., a carboxylate-containing organic compound). Examples of conjugate bases of organic acids include, but are not limited to, formate, acetate, lactate, oxalate, and/or citrate. Another example of an organic acid is benzoic acid. In some embodiments, the anions referenced here do not include carbonate ions and/or bicarbonate ions (though one or both of carbonate anions and bicarbonate anions may also be present in the aqueous input stream in some embodiments). In some embodiments, the anions are conjugate bases of strong acids. However, in some embodiments, the anions are conjugate bases of weak acids. In some embodiments, the anions are spectator ions with respect to the chemistries employed by the electrochemical assembly and/or other reactions performed in the methods and systems of this disclosure.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are non-hydroxide anions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are chloride ions.

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous input stream are sulfate ions (SO₄²⁻) and/or hydrogen sulfate ions (HSO₄⁻).

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions in the aqueous input stream are sulfate ions (SO₄²⁻).

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are phosphate ions (e.g., monohydrogen phosphate ions, dihydrogen phosphate ions, and/or dihydrogen phosphate ions). In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are monohydrogen phosphate ions. In some embodiments, some (e.g., at least 1 mol %, at least mol %, at least 20 mol %, at least 50 mol %, at least 75 mol %, at least 95 mol %, at least 98 mol %, at least 99 mol %) or all of the anions are dihydrogen phosphate ions.

As noted above, the anions may be present in the aqueous input stream in a relatively high concentration. In some embodiments, the dissolved anions are present in the aqueous input stream at a concentration of greater than or equal to 0.1 moles per liter (M), greater than or equal to 0.3 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6, M, up to 7 M, up to 8 M, up to 10 M, up to 20 M, or greater. Combinations of these ranges (e.g., greater than or equal to 0.1 M and up to 20 M, greater than or equal to 0.1 M and up to 10 M, greater than or equal to 0.3 M and up to 6 M) are possible.

In some embodiments, a dissolved alkali metal chloride is present in the aqueous input stream. For example, the aqueous input stream may comprise a dissolved alkali metal chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, up to 20 M, or greater. Combinations of these ranges are possible.

In some embodiments, dissolved sodium chloride is present in the aqueous input stream. For example, the aqueous input stream may comprise dissolved sodium chloride in an amount of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, or greater. Combinations of these ranges (e.g., greater than or equal to 0.1 M and less than or equal to 7 M, greater than or equal to 1 M and less than or equal to 6 M) are possible.

In some embodiments, dissolved potassium chloride is present in the aqueous input stream. For example, the aqueous input stream may comprise dissolved potassium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, dissolved lithium chloride is present in the aqueous input stream. For example, the aqueous input stream may comprise dissolved lithium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M, or greater. Combinations of these ranges (e.g., greater than or equal to 0.1 M and less than or equal to 8 M, greater than or equal to 1 M and less than or equal to 5 M) are possible.

In some embodiments, a dissolved alkali orthophosphate (e.g., potassium orthophosphate and/or sodium orthophosphate) is present in the aqueous input stream. For example, the aqueous input stream may comprise dissolved alkali orthophosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible. In some embodiments, a dissolved alkali monohydrogen phosphate (e.g., potassium monohydrogen phosphate and/or sodium monohydrogen phosphate) is present in the aqueous input stream. For example, the aqueous input stream may comprise dissolved alkali monohydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible. In some embodiments, a dissolved alkali dihydrogen phosphate (e.g., potassium dihydrogen phosphate and/or sodium dihydrogen phosphate) is present in the aqueous input stream. For example, the aqueous input stream may comprise dissolved alkali dihydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges are possible.

In some embodiments, dissolved carbonate anions are present in the aqueous input stream in addition to the other anions discussed above. For example, the aqueous input stream may comprise dissolved carbonate anions in an amount of greater than or equal to 0.005 M, greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

In some embodiments, dissolved bicarbonate anions are present in the aqueous input stream in addition to the other anions discussed above. For example, the aqueous input stream may comprise dissolved bicarbonate anions in an amount of greater than or equal to 0.005 M. For example, the aqueous input stream may comprise dissolved bicarbonate anions in an amount of greater than or equal to 0.01 M, greater than or equal to 0.02 M, greater than or equal to 0.05 M, greater than or equal to 0.1 moles per liter (M), greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

The aqueous input stream may have any of a variety of pH values, depending on the composition of the stream and the configuration of the system. The aqueous input stream may have a relatively low pH (e.g., in instances where acid (electrogenerated or otherwise) is present). In some embodiments, the aqueous input stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous input stream may have a relatively high pH (e.g., in instances where base (electrogenerated or otherwise) is present). In some embodiments, the aqueous input stream has a pH of greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

The electrochemical assembly may have any of a variety of configurations, depending on, for example, the arrangement of the overall system and/or the desired electrochemistries to be employed in electrogenerating product species. Upon transport to the electrochemical assembly, at least one component of the aqueous input stream (e.g., dissolved species and/or solvent molecules such as water molecules) may be involved with one or more electrochemically-induced reactions. For example, a cation and/or an anion of the aqueous input stream may be involved in the one or more reactions by serving as a counter-ion for an electrogenerated product (e.g., thereby preserving charge neutrality). For example, a sodium cation from the aqueous input stream becoming a countercation for electrogenerated hydroxide in the electrochemical cell is an example of a component of the aqueous input stream being involved with the one or more reactions. As another example, water from the aqueous input stream undergoing an oxidation or reduction reaction such as the oxygen evolution reaction or the hydrogen evolution reaction as part of the one or more reactions is an example of a component of the aqueous input stream being involved with the one or more reactions. As yet another example, in some embodiments the electrochemical cell comprises an electrodialysis cell comprising a bipolar membrane. In some such embodiments where water in the aqueous input stream becomes dissociated into protons (as part of hydronium ions) and hydroxide ions at a bipolar membrane, that water is considered to be a component of the aqueous input stream being involved with the one or more reactions (e.g., induced by the application of the electrical potential). As yet another example, in some embodiments, the electrochemical cell is a fuel cell. For example, the electrochemical may be a fuel cell that consumes a molecule such as H₂.

The reactions may result, directly or indirectly, in the production of a basic species. The basic species may promote downstream capture of carbon dioxide.

In some embodiments, the reactions may result, directly or indirectly, in the production of a protic species. For example, the protic species may comprise an acidic species. The protic species may promote downstream release of captured carbon dioxide.

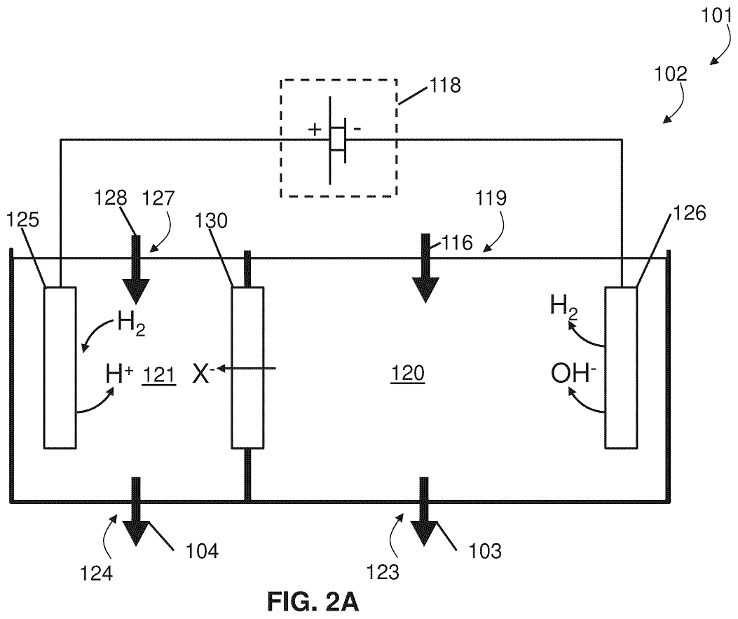

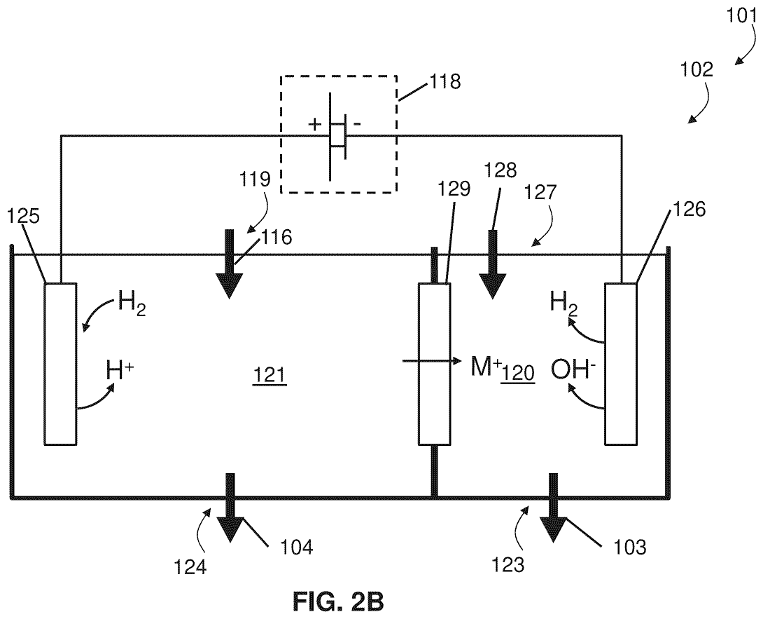

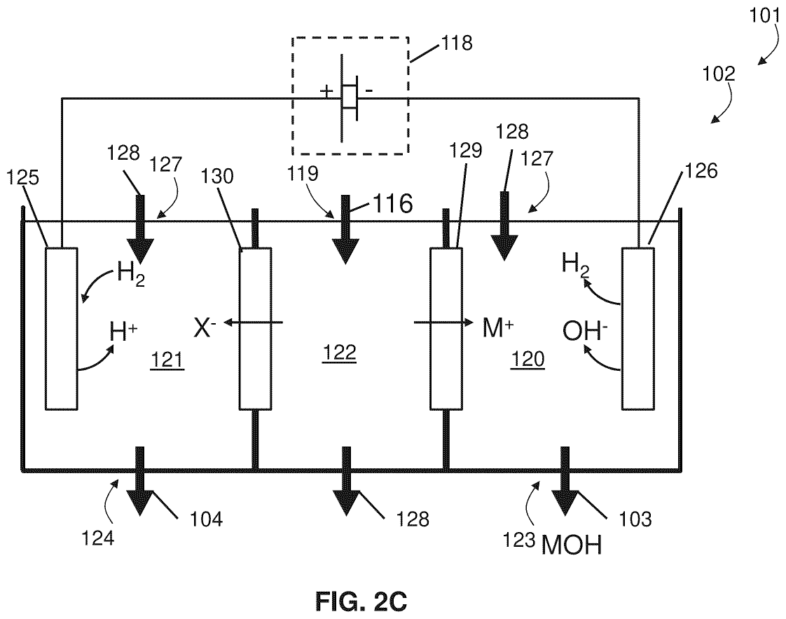

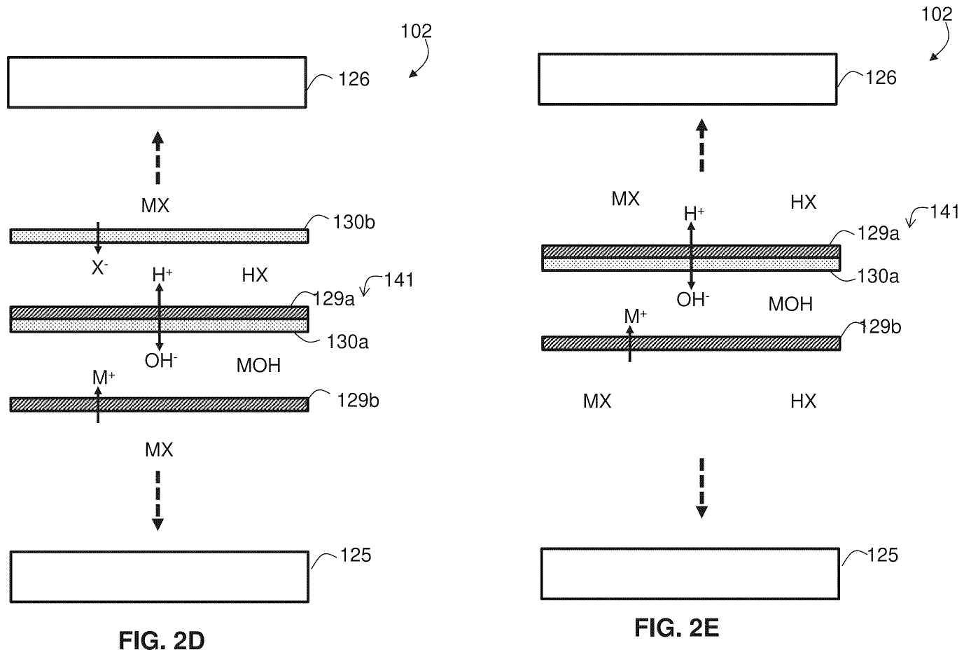

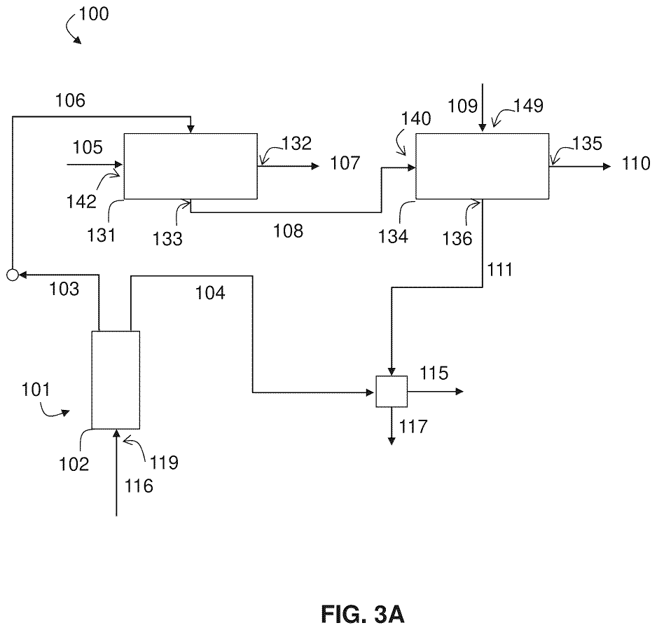

In some embodiments, the electrochemical assembly includes an electrochemical cell. FIGS. 2A-2C show cross-sectional schematic illustrations of non-limiting examples of embodiments of electrochemical assemblies 101 comprising electrolytic cell 102. In some embodiments, the electrochemical cell is an electrolytic cell. An electrolytic cell generally comprises an anode and a cathode and is configured to use electrical energy to drive a chemical reaction that is thermodynamically non-spontaneous under the conditions of the reaction (e.g., temperature and pressure). The electrochemical cell may be a flow cell. The flow cell may be configured to receive one or more liquid streams (e.g., comprising reagents and/or electrolyte components). The flow cell may be configured to output one or more product streams comprising an electrogenerated product.

The embodiments in FIGS. 2A-2C use the hydrogen evolution and hydrogen reduction reactions as illustrative half reactions that can be employed in an overall chemical reaction that can be performed in the electrochemical cell. However, other chemistries (e.g., chloralkali chemistries or other chemistries involving different half reactions) can also be employed.

While the electrochemical assemblies shown in FIGS. 2A-2C have a single electrochemical cell, some electrochemical assemblies may include multiple electrochemical cells (e.g., at least 2 cells, at least 3 cells, at least 4 cells, at least 5 cells, at least 10 cells, at least 50 cells, at least 100 cells, at least 500 cells, at least 1,000 cells, at least 5,000 cells, at least 10,000 cells, at least 15,000 cells, at least 25,000 cells, at least 50,000 cells, at least 100,000 cells, and/or up to 200,000 cells, up to 250,000 cells, up to 500,000 cells, up to 1,000,000 cells, or more). Combinations of these ranges (e.g., at least 2 cells and less than or equal to 1,000,000 cells, at least 15,000 cells and less than or equal to 25,000 cells) are possible. The multiple electrochemical cells may be fluidically arranged in parallel and/or in series.

The electrochemical cell may drive one or more reactions ultimately producing base-rich product solutions, as discussed below. In some embodiments, the one or more reactions also ultimately produce proton-rich product solutions, as also discussed below. The electrochemical cell may drive one or more of such reactions upon application of an electrical potential difference across the electrochemical cell. The potential difference may be applied across the anode and the cathode such that the thermodynamic barrier (and in some instances kinetic barrier) to the overall cell reaction is overcome, thereby initiating the cell reaction to occur via electron transfers that effect the respective half reactions. The magnitude of the electrical potential difference may be greater than or equal to 0.5 V, greater than or equal to 0.9 V, greater than or equal to 1.0 V, greater than or equal to 1.3 V, and/or up to 1.5 V, up to 1.8 V, up to 2 V, up to 2.5 V, up to 3 V, or higher. Combinations of these ranges (e.g., greater than or equal to 0.5 V and less than or equal to 3 V, greater than or equal to 0.9 and less than or equal to 1.5 V) are possible.

In FIGS. 2A-2C, for example, electrical potential difference 118 is applied across electrochemical cell 102 to initiate the chemical reactions shown.

In some embodiments, the electrochemical assembly includes one or more (e.g., at least one, at least two, at least three, or more) liquid inlets. The aqueous input stream may enter the electrochemical cell via one or more of these inlets. The liquid inlets may be configured to supply dissolved ions to the anode (e.g., in an anolyte chamber) and/or the cathode (e.g., in a catholyte chamber). In some embodiments, one or more of the liquid inlets are part of the electrochemical cell itself, although in other embodiments, the liquid inlets are upstream of the cell (e.g., connected to a separate conduit that feeds the cell or an upstream unit operation within the assembly). In some embodiments, a single liquid inlet feeds both the anode and the cathode (and/or a third chamber between anolyte and catholyte chambers). However, in other embodiments, a first liquid inlet supplies dissolved ions to the cathode (e.g., as part of a catholyte solution) and a second liquid inlet supplies dissolved ions to the anode (e.g., as part of an anolyte solution).

In the embodiment shown in FIG. 2A, aqueous input stream 116 (e.g., comprising the dissolved cations and dissolved anions) is fed as catholyte into catholyte chamber 120 via liquid inlet 119 (and electrolyte solution 128 is fed as anolyte into anolyte chamber 121 via liquid inlet 127). In the embodiment shown in FIG. 2B, aqueous input stream 116 (e.g., comprising the dissolved cations and dissolved anions) is fed as anolyte into anolyte chamber 121 via liquid inlet 119 (and electrolyte solution 128 is fed as catholyte into catholyte chamber 120 via liquid inlet 127). In the embodiment shown in FIG. 2C, aqueous input stream 116 (e.g., comprising the dissolved cations and dissolved anions) is fed into electrolyte chamber 122 via liquid inlet 119 (and electrolyte solution 128 is fed as catholyte into catholyte chamber 120 via liquid inlet 127, and also electrolyte solution 128 is fed as anolyte into anolyte chamber 121 via liquid inlet 127).

In some embodiments, the electrochemical assembly includes two or more (e.g., at least two, at least three, or more) liquid outlets. The reaction products from one or more chemical reactions performed in the electrochemical assembly initiated by the application of the electrical potential difference may be output from the electrochemical assembly via these outlets. For example, the electrochemical assembly may include a first electrochemical assembly liquid outlet and a second electrochemical assembly liquid outlet.

The electrochemical assembly liquid outlet may be configured to output a base-rich product solution (e.g., generated in a catholyte chamber and/or from an electrodialysis stream). For example, the electrochemical assembly liquid outlet may be in fluid communication with a catholyte chamber of the electrochemical cell. For example, in FIGS. 2A-2C, first liquid outlet 123 is in fluid communication with catholyte chamber 120 of electrochemical cell 102. At least a portion of base-rich product solution 103 generated by electrochemical assembly 101 may be output by first liquid outlet 123 (e.g., to a conduit to be transported to a downstream process and/or to be collected). It should be understood here and elsewhere that the terms “liquid inlet”, “liquid outlet”, “gas inlet”, and “gas outlet” are used for convenience in identifying various components of the system and to, generally, refer to states of matter most significantly contributing to the material that passes through them; these terms are not meant to imply that the material passing through these components must be completely single-phase (e.g., completely liquid with no gaseous component or vice versa).

In some embodiments in which the electrochemical assembly comprises a second electrochemical assembly liquid outlet, the second electrochemical assembly liquid outlet is configured to output a proton-rich product solution (e.g., generated in an anolyte chamber and/or from an electrodialysis stream). For example, the second electrochemical assembly liquid outlet may be in fluid communication with an anolyte chamber of the electrochemical cell. For example, in FIGS. 2A-2C, second liquid outlet 124 is in fluid communication with anolyte chamber 121 of electrochemical cell 102. At least a portion of proton-rich product solution 104 generated by electrochemical assembly 101 may be output by second liquid outlet 124 (e.g., to a conduit to be transported to a downstream process and/or to be collected). While the liquid outlets are shown as being directly part of electrochemical cell 102 in FIGS. 2A-2C, other configurations are possible. For example, while in some embodiments, one or more of the liquid outlets are part of the electrochemical cell itself, in other embodiments, the liquid outlets are downstream of the cell (e.g., connected to a separate conduit that feeds the downstream processes such as chambers or reactors for further reactivity (e.g., as in a chloralkali assembly in which hydrogen gas and chlorine gas electrolytic products are reacted to form HCl to produce the proton-rich product solution)).

As mentioned above, the electrochemical cell may comprise an anode and a cathode. As mentioned above, in some embodiments the electrochemical cell is an electrolytic cell. In an electrolytic cell, the anode, also referred to as the positive electrode, is used to promote an electrochemical oxidation half reaction. For example, in the embodiments shown in FIGS. 2A-2C, anode 125 is configured to perform the hydrogen oxidation reaction, in which hydrogen gas is oxidized to form protons: ½ H₂→H⁺+e⁻ (with the electrons collected by anode 125 and transported to cathode 126 as part of the electrical circuit). Any of a variety of materials may be used for or as part of the anode, generally including an electronically conductive solid. In some embodiments, the anode comprises a conductive metal or metal alloy such as platinum, nickel, stainless steel, titanium, platinized titanium, silver, gold, or combinations thereof). In some embodiments, the anode is a gas diffusion electrode and/or comprises a gas diffusion layer (e.g., a carbon and/or metallic gas diffusion electrode and/or layer). In some embodiments, the anode comprises a catalyst configured to accelerate the reaction to occur at the anode (e.g., hydrogen oxidation). For example, the anode may comprise a platinum-group catalyst such as platinum. In some embodiments, the anode comprises a carbonaceous material (e.g., carbon black). The carbonaceous material may be combined with a polymer material (e.g., polytetrafluorethylene).

In some embodiments, the electrochemical cell comprises an anolyte chamber. The anolyte chamber may be in fluid communication with at least a portion of the anode (e.g., the anode may be at least partially submerged in anolyte that is present in the anolyte chamber). At least a portion (or all) of the anode may be located within the anolyte chamber. In the embodiments shown in FIGS. 2A-2C, anode 125 is submerged in anolyte in anolyte chamber 121.

In an electrolytic cell, the cathode, also referred to as the negative electrode, is used to promote an electrochemical reduction half reaction. For example, in the embodiments shown in FIGS. 2A-2C, cathode 126 is configured to perform the hydrogen evolution reaction, in which hydrogen gas is generated by the reduction of water (or protons from water): 2H₂O+2e⁻→H₂+2OH⁻ (with the electrons provided by cathode 126 after having been transported to cathode 126 from anode 125 as part of the electrical circuit). Any of a variety of materials may be used for the cathode, generally including an electronically conductive solid (e.g., a conductive metal or metal alloy such as platinum, nickel, ruthenium, stainless steel, or combinations thereof). As one example, the cathode may comprises nickel coated with a platinum group metal (e.g., platinum). However, in some embodiments, the cathode comprises a nickel substrate with a catalyst coating comprising a non-platinum group metal such as a non-platinum group transition metal. In some embodiments, the cathode comprises a catalyst configured to accelerate the reaction to occur at the cathode (e.g., hydrogen evolution).

In some embodiments where the hydrogen evolution reaction is performed at the cathode and the hydrogen oxidation reaction is performed at the anode, at least some of (that is, some or all of) the hydrogen gas reactant at the anode is supplied from the product hydrogen gas generated at the cathode. For example, a conduit may be configured to collect hydrogen gas produced in the catholyte chamber and transport the hydrogen gas to the anolyte chamber for consumption.

In some embodiments, the electrochemical cell comprises a catholyte chamber. The catholyte chamber may be in fluid communication with at least a portion of the cathode (e.g., the cathode may be at least partially submerged in catholyte that is present in the catholyte chamber). At least a portion (or all) of the cathode may be located within the catholyte chamber. In the embodiments shown in FIGS. 2A-2C, cathode 126 is submerged in catholyte in catholyte chamber 120.

In some embodiments, the two or more chambers and/or streams of the electrochemical cell are separated by at least one separator (e.g., comprising a membrane and/or diaphragm). For example, in some embodiments, the electrochemical cell comprises a catholyte chamber and an anolyte chamber separated by at least one separator (e.g., comprising a membrane and/or diaphragm). In some embodiments, the separator is not ion-selective. For example, the separator may comprise a porous media and separate the electrolyte compartments by limiting convective flow and/or molecular diffusion, without substantial (or any) ion selectivity. However, in some embodiments, the separator is ion-selective. For example, in some embodiments, the catholyte chamber and the anolyte chamber are separated by at least one ion-selective membrane (e.g., at least one ion-selective membrane, at least two ion selective membranes, or more). In this context, the separation refers to the membrane limiting or preventing transport of at least one type of ion from the catholyte chamber to the anolyte chamber or vice versa. Any of a variety of ion-selective membranes may be used. For example, the membrane may be a semi-permeable membrane (e.g., a semi-permeable polymer membrane, ceramic membrane, or combination thereof).

In some embodiments, at least one ion-selective membrane in the electrochemical cell comprises a cation-selective membrane. In some such embodiments, the aqueous input stream is transported to the anolyte chamber. For example, in the embodiment shown in FIG. 2B, aqueous input stream 116 comprising dissolved salt MX is transported to anolyte chamber 121 via liquid inlet 119, and cations M⁺ (e.g., sodium ions and/or potassium ions) migrate through cation-selective membrane 129 from anolyte chamber 121 to catholyte chamber 120. Cation M⁺ helps maintain charge neutrality and can be expelled from catholyte chamber 120 as part of base-rich product solution 103 (e.g., as a counter-cation to electrogenerated basic species such as hydroxide ions).

In some embodiments, at least one ion-selective membrane in the electrochemical cell comprises an anion-selective membrane. In some such embodiments, the aqueous input stream is transported to the catholyte chamber. For example, in the embodiment shown in FIG. 2A, aqueous input stream 116 comprising dissolved salt MX is transported to catholyte chamber 120 via liquid inlet 119, and anions X⁻ (e.g., halide ions such as chloride ions, sulfate ions, nitrate ions, phosphate ions) migrate through anion-selective membrane 130 from catholyte chamber 120 to anolyte chamber 121. Anion X helps maintain charge neutrality and can be expelled from anolyte chamber 121 as part of proton-rich product solution 104 (e.g., as a counter-anion to electrogenerated protic species such as protons/hydronium ion or to other cations that may be present).

In some embodiments, the electrochemical cell further comprises an electrolyte chamber other than the catholyte chamber and the anolyte chamber. The electrolyte chamber may be separated from the catholyte chamber by a cation-selective membrane. For example, in FIG. 2C, electrolyte chamber 122 is separated from catholyte chamber 120 by cation-exchange membrane 129, where cations M⁺ can migrate from electrolyte chamber 122 to catholyte chamber 120. In some embodiments, the electrolyte chamber is separated from the anolyte chamber by an anion exchange membrane. For example, in FIG. 2C, electrolyte chamber 122 is separated from anolyte chamber 121 by anion-exchange membrane 130, where anions X can migrate from electrolyte chamber 122 to anolyte chamber 121. In some embodiments in which there is an electrolyte chamber separated from the anolyte chamber and the catholyte chamber in the electrochemical cell, the aqueous input stream comprising dissolved salt is transported to that electrolyte chamber (e.g., via one of the electrochemical assembly inlets). For example, in FIG. 2C, aqueous input stream 116 comprising dissolved salt MX is fed to electrolyte chamber 122 via liquid inlet 119. In some embodiments, the electrolyte chamber is in fluid communication with a liquid outlet. For example, in some embodiments, an aqueous input stream comprising concentrated dissolved salt MX is transported via a liquid inlet to the electrolyte chamber, and an electrolyte outlet stream is output from the electrolyte chamber via a liquid outlet, with the electrolyte outlet stream having a lower concentration of dissolved MX than the aqueous input stream (e.g., by a factor of at least 1.01, at least 1.02, at least 1.05, at least 1.1, at least 1.2, at least, 1.5, at least 2, at least 5, at least 10, at least 20, and/or up to 50, up to 100, or more). Combinations of these ranges (e.g., at least 1.01 and less than or equal to 100, at least 1.01 and less than or equal to 5) are possible. As an illustrative example, if an electrolyte outlet stream has a concentration of dissolved MX of 0.2 M and the aqueous input stream has a concentration of MX of 1.0 M, then the electrolyte outlet stream has a concentration of MX that is lower than that of the aqueous input stream by a factor of 5 because 0.2 M times 5 equals 1.0 M.

Non-limiting examples of suitable electrochemical assembly and electrochemical cell configurations for at least some embodiments are described in U.S. Pat. No. 7,790,012 by Kirk et al., issued Sep. 7, 2010, which is incorporated herein by reference in its entirety for all purposes.

While the hydrogen evolution and hydrogen oxidation half-cell reactions are described in detail above and below, those reactions are illustrative, and other chemistries may be employed. For example, the electrolytic assembly may be configured to perform water electrolysis, where the hydrogen evolution reaction at the cathode is coupled to the oxygen evolution reaction at the anode. As another example, the electrolytic assembly may be configured to perform the oxygen reduction reaction at the cathode and one or more of the hydrogen oxidation reaction, the chlorine gas (Cl₂) evolution reaction, or the oxygen evolution reaction at the anode. As yet another example, the electrolytic assembly may be configured to perform a carbon dioxide reduction at the cathode and the oxygen evolution reaction at the anode.

In some embodiments, the electrochemical cell is configured to be operated as an electrodialysis cell. The cathode electrolysis and anode electrolysis half-reactions in an electrolytic cell configured as an electrodialysis cell may create electric fields that drive separation of cations and anions (e.g., using semi-permeable membranes such as ion-selective membranes). In some embodiments, the electrochemical cell comprises a cathode, an anode, and two or more semi-permeable membranes (e.g., two or more ion-selective membranes) separating the cathode and the anode. In some embodiments, the electrochemical cell comprises a bipolar membrane as at least one of the semi-permeable membranes. A bipolar membrane may comprise an anion-selective membrane layer and a cation-selective membrane layer configured to create a junction at an interface between the anion-selective membrane layer and the cation-selective membrane layer (e.g., upon being pressed together). The bipolar membrane may be configured to promote dissociation of water at the junction to form protons (e.g., as hydronium cations) and hydroxide anions. In some, but not necessarily all embodiments, the bipolar membrane comprises a water dissociation catalyst, which may enhance the rate of water dissociation.

FIG. 2D shows a schematic cross-sectional diagram of an embodiment in which electrochemical cell 102 is configured as an electrodialysis cell comprising bipolar membrane 141. Application of an electrical potential difference across electrochemical cell 102 may initiate a cathode electrolysis half reaction at cathode 126 and an anode electrolysis half reaction at anode 125 of electrochemical cell 102. The cathode electrolysis half reaction may generate negative charge near cathode 126, thereby generating an electric field attracting cations. The anode electrolysis half reaction may generate positive charge near anode 125, thereby generating an electric field attracting anions. Bipolar membrane 141 comprises cation-selective membrane 129a and anion-selective membrane 130a configured to dissociate water into H⁺ and OH⁻. The dissociated H⁺ may diffuse from cation-selective membrane 129a of bipolar membrane 141 toward cathode 126, while the dissociated OH⁻ may diffuse from anion-selective membrane 130a toward anode 125. Additionally, anion-selective membrane 130b may separate cation-selective membrane 129a and cathode 126, thereby reducing or stopping transport of the diffusing H⁺ toward cathode 126 while permitting dissolved anion X⁻ from dissolved salt MX (e.g., NaCl) to cross anion-selective membrane 130b in the opposite direction. As a result, a product solution comprising dissolved HX may be formed in the space between anion-selective membrane 130b and cation-selective membrane 129a. Such a product solution may form some or all of a proton-rich product solution (e.g., an acid-rich product solution) output by electrochemical cell 102.

Meanwhile, in FIG. 2D, cation-selective membrane 129b may separate anion-selective membrane 130a and anode 125, thereby reducing or stopping transport of the diffusing OH toward anode 125 while permitting dissolved metal cation M⁺ from dissolved salt MX (e.g., NaCl) to cross cation-selective membrane 129b in the opposite direction. As a result, a product solution comprising dissolved MOH may be formed in the space between cation-selective membrane 129b and anion-selective membrane 130a. Such a product solution may form some or all of the base-rich product solution output by electrochemical cell 102.

FIG. 2E shows a schematic cross-sectional illustration of another embodiment in which electrochemical cell 102 is configured as an electrodialysis cell, but without use of a separate anion-selective membrane in addition to that in bipolar membrane 141. As before, the dissociated H⁺ may diffuse from cation-selective membrane 129a of bipolar membrane 141 toward cathode 126, while the dissociated OH— may diffuse from anion-selective membrane 130a toward anode 125. The diffusing H⁺ may become exposed to solution comprising X from dissolved salt MX (e.g., NaH₂PO₄). As a result, a product solution comprising dissolved HX (e.g., H₃PO₄) may be formed on the side of cation-selective membrane 129a closest to cathode 126. Such a product solution may form some or all of a product stream (e.g., a proton-rich product solution such as an acid-rich product solution) output by electrochemical cell 102.

Meanwhile, in FIG. 2E, cation-selective membrane 129b may separate anion-selective membrane 130a and anode 125, thereby reducing or stopping transport of the diffusing OH toward anode 125 while permitting dissolved metal cation M⁺ from dissolved salt MX (e.g., NaH₂PO₄) to cross cation-selective membrane 129b in the opposite direction. As a result, a product solution comprising dissolved MOH (e.g., NaOH) may be formed in the space between cation-selective membrane 129b and anion-selective membrane 130a. Such a product solution may form some or all of the base-rich product solution output by electrochemical cell 102.

The arrangements of ion-selective membranes shown in FIGS. 2D-2E may be repeated any of a variety of times to form a stack between the cathode, which may be at one end of a stack, and the anode, which may be at the opposite end of the stack.

In some embodiments, the cathode electrolysis half reaction (e.g., of the electrodialysis cell) is the hydrogen evolution reaction. In some embodiments, the cathode electrolysis half reaction (e.g., of the electrodialysis cell) is the oxygen reduction reaction. In some embodiments, the cathode electrolysis half reaction (e.g., of the electrodialysis cell) is a carbon dioxide reduction reaction. In some embodiments, the anode electrolysis half reaction (e.g., of the electrodialysis cell) is the hydrogen oxidation reaction. In some embodiments, the anode electrolysis half reaction (e.g., of the electrodialysis cell) is the oxygen evolution reaction. In some embodiments, the cathode electrolysis half reaction of the (e.g., of the electrodialysis cell) is the hydrogen evolution reaction and the anode electrolysis half reaction is the oxygen evolution reaction. In some embodiments, the cathode electrolysis half reaction (e.g., of the electrodialysis cell) is the hydrogen evolution reaction and the anode electrolysis half reaction is the hydrogen oxidation reaction. In some embodiments, the cathode electrolysis half reaction (e.g., of the electrodialysis cell) is the oxygen reduction reaction and the anode electrolysis half reaction is the oxygen evolution reaction. In some embodiments, the cathode electrolysis half reaction (e.g., of the electrodialysis cell) is a carbon dioxide reduction reaction and the anode electrolysis half reaction is the oxygen evolution reaction. In some embodiments, the cathode electrolysis half reaction (e.g., of the electrodialysis cell) is the oxygen reduction reaction and the anode electrolysis half reaction is the hydrogen oxidation reaction.

In some embodiments in which the electrochemical cell is an electrolytic cell, the cathode electrolysis half reaction of the electrolytic cell (e.g., in the catholyte chamber) is the hydrogen evolution reaction. In some embodiments in which the electrochemical cell is an electrolytic cell, the cathode electrolysis half reaction of the electrolytic cell (e.g., in the catholyte chamber) is the oxygen reduction reaction. In some embodiments in which the electrochemical cell is an electrolytic cell, the cathode electrolysis half reaction of the electrolytic cell (e.g., in the catholyte chamber) is a carbon dioxide reduction reaction. In some embodiments in which the electrochemical cell is an electrolytic cell, the anode electrolysis half reaction of the electrolytic cell (e.g., in the anolyte chamber) is the hydrogen oxidation reaction. In some embodiments in which the electrochemical cell is an electrolytic cell, the anode electrolysis half reaction of the electrolytic cell (e.g., in the anolyte chamber) is the oxygen evolution reaction. In some embodiments in which the electrochemical cell is an electrolytic cell, the cathode electrolysis half reaction of the electrolytic cell (e.g., in the catholyte chamber) is the hydrogen evolution reaction and the anode electrolysis half reaction (e.g., in the anolyte chamber) is the oxygen evolution reaction. In some embodiments in which the electrochemical cell is an electrolytic cell, the cathode electrolysis half reaction of the electrolytic cell (e.g., in the catholyte chamber) is the hydrogen evolution reaction and the anode electrolysis half reaction (e.g., in the anolyte chamber) is the hydrogen oxidation reaction. In some embodiments in which the electrochemical cell is an electrolytic cell, the cathode electrolysis half reaction of the electrolytic cell (e.g., in the catholyte chamber) is the oxygen reduction reaction and the anode electrolysis half reaction (e.g., in the anolyte chamber) is the oxygen evolution reaction. In some embodiments in which the electrochemical cell is an electrolytic cell, the cathode electrolysis half reaction of the electrolytic cell (e.g., in the catholyte chamber) is a carbon dioxide reduction reaction and the anode electrolysis half reaction (e.g., in the anolyte chamber) is the oxygen evolution reaction. In some embodiments in which the electrochemical cell is an electrolytic cell, the cathode electrolysis half reaction of the electrolytic cell (e.g., in the catholyte chamber) is the oxygen reduction reaction and the anode electrolysis half reaction (e.g., in the anolyte chamber) is the hydrogen oxidation reaction. In some such embodiments, employing the oxygen reduction reaction and the hydrogen oxidation reaction as the respective half-reactions in the cathode and anode can facilitate the generation of electricity in a system capable of capturing and in some instances releasing carbon dioxide.

As discussed above, a base-rich product solution may be formed as a result of the one or more reactions performed via the electrochemical cell. For example, in FIG. 1A, at least a portion of base-rich product solution is output from electrochemical assembly 101 as stream 103. The base-rich product solution may be formed, for example, in the catholyte chamber of the electrochemical cell. The base-rich product solution may be formed using a batch, semi-batch, or continuous process involving the electrochemical cell.

The base-rich product solution may comprise electrogenerated basic species. The electrogenerated basic species may be dissolved in an aqueous solution. The electrogenerated basic species may be a direct or indirect product of the one or more chemical reactions performed in the electrochemical assembly. The electrogenerated basic species may be a source of alkalinity for the solution. For example, the electrogenerated basic species may be a species whose conjugate acid has a relatively high pKa. The basic species may have a conjugate acid having a pKa of greater than or equal to 10, greater than or equal to 10.3, greater than or equal to 10.5, greater than or equal to 11, greater than or equal to 12, greater than or equal to 14, greater than or equal to 15, and/or up to 15.7, up to 16, or greater in water at a temperature of 298 K. Combinations of these ranges are possible. In some embodiments, the electrogenerated basic species comprise hydroxide ions (OH⁻). One way in which the hydroxide ions may be generated is from the hydrogen evolution reaction (e.g., in the catholyte chamber). As another example, the electrogenerated basic species may comprise carbonate ions (CO₃²⁻). The carbonate ions may be generated from deprotonation of dissolved carbonic acid (from dissolved carbon dioxide) by electrogenerated hydroxide ions, either in the catholyte chamber or in a different component of the system.

When a specific type of molecule or ion (e.g., a basic species) is described as being “generated” from or “electrogenerated from” a particular material and/or stream via a chemical reaction (e.g., a chemical reaction as described above), the specific ions/molecules (e.g., of the basic species) contained within a different material (e.g., a base-rich product solution) may not be literally the exact same ions/molecules of the basic species directly produced by the chemical reaction (e.g., the electrochemical reactions discussed above), as those generated (e.g., electrogenerated) ions/molecules may undergo, for example, one or more proton transfers with other species in solution to create equivalent species. For example, a first hydroxide ion generated at an electrode of the electrochemical cell may later deprotonate a first neutral water molecule in the base-rich product solution to generate a second hydroxide ion and a second neutral water molecule, and so the composition of the base-rich product solution would be unchanged. If the second, equivalent hydroxide ion (or a third, equivalent hydroxide ion from yet another proton transfer, and so on) then participated in a later step of the process (e.g., if the second, equivalent hydroxide ion was exposed to carbon dioxide from an input gas stream), then that would still be considered participation of the generated (e.g., electrogenerated) species in the later step of the process (e.g., exposure of an electrogenerated hydroxide ion to the carbon dioxide).

The basic species (e.g., hydroxide ions) may be present in the base-rich product solution in a relatively high concentration (which may promote effective carbon dioxide capture elsewhere in the system). It should be understood that the name “base-rich product solution” is used for convenience in identifying the solution, and is not meant to imply any particular absolute or relative concentration of base in the solution. In some embodiments, the basic species (e.g., hydroxide ions) is present in the base-rich product solution at a concentration of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, or greater than or equal to 1 M and less than or equal to 10 M) are possible. In some embodiments, the molar ratio of the concentration of the basic species (e.g., hydroxide ions) in the base-rich product solution to the concentration of the basic species in the aqueous input stream and/or a stream fed to the catholyte compartment (e.g., which itself may be the aqueous input stream or a different electrolyte stream) is at least 1.005, at least 1.01, at least 1.05, at least 1.1, at least 1.2, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, the base-rich product solution has a relatively high pH. For example, in some embodiments, the base-rich product solution has a pH of greater than or equal to 8, greater than or equal to 9, greater than or equal to 10, greater than or equal to 11, greater than or equal to 12, greater than or equal to 13, greater than or equal to 14, and/or up to 15, up to 16, or greater. Combinations of these ranges are possible. In some embodiments, the pH of the base-rich product solution is greater than the pH of the aqueous input stream and/or a stream fed to the catholyte compartment (e.g., by at least 0.05 pH units, at least 1 pH unit, at least 1.5 pH units, at least 2 pH units, at least 3 pH units, at least 4 pH units, at least 5 pH units, at least 6 pH units, and/or up to 7 pH units, up to 8 pH units, up to 9 pH units, up to 10 pH units, or more).

In some embodiments, the base-rich product solution comprises at least some of the cations (e.g., the metal cations and/or ammonium cations discussed above). The cations may be from the aqueous input stream. The cations in the base-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the cations in the aqueous input stream. For example, an aqueous input solution comprising dissolved MX (e.g., NaCl) may be transported to the electrochemical cell, and a base-rich product solution comprising dissolved MOH (e.g., NaOH) may be produced by the electrochemical cell.

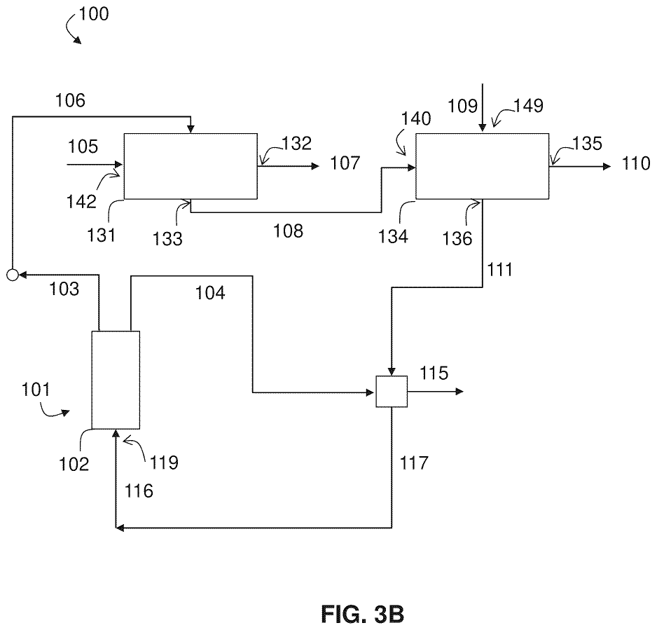

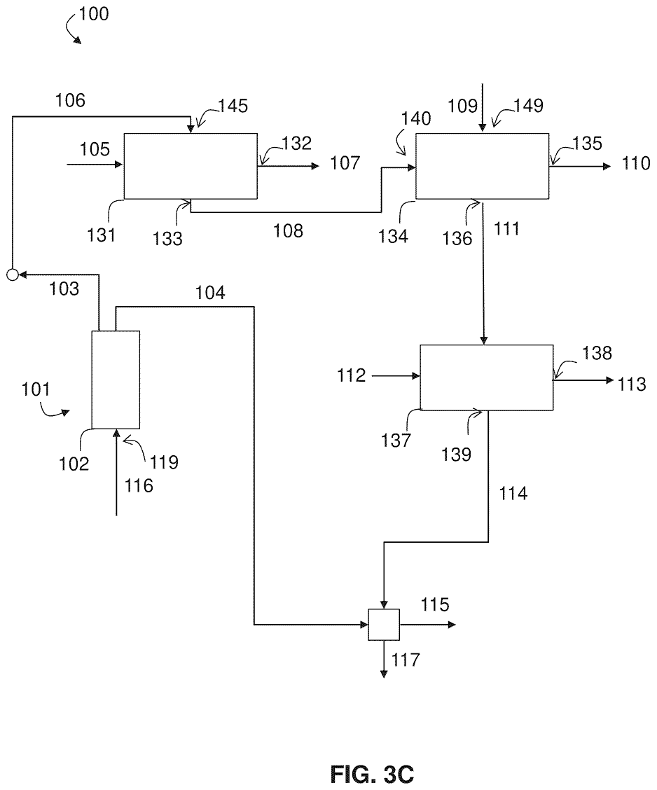

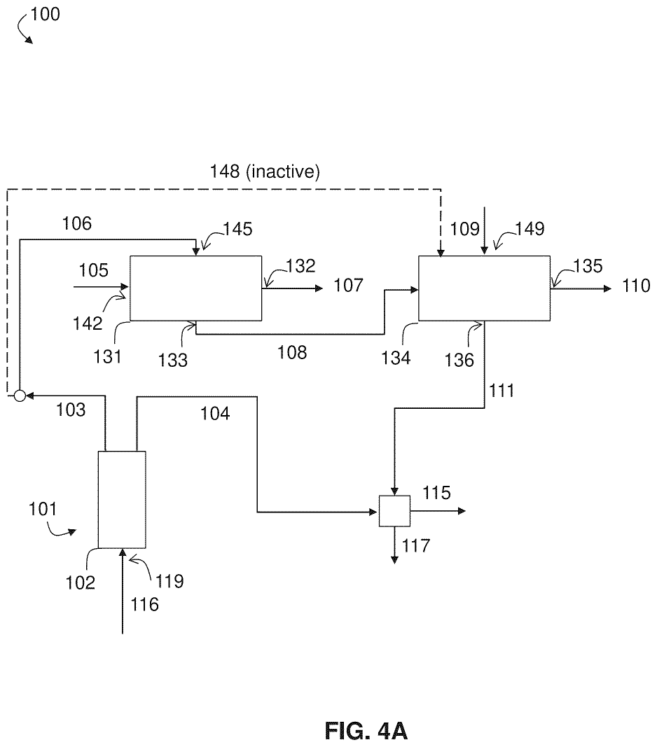

As discussed above, a proton-rich product solution may be formed as a result of the one or more reactions performed via the electrochemical cell. For example, in FIG. 3A, at least a portion of proton-rich product solution is output from electrochemical assembly 101 as stream 104. The proton-rich product solution may be formed, for example, in the anolyte chamber of the electrochemical cell. The proton-rich product solution may be formed using a batch, semi-batch, or continuous process involving the electrochemical cell.

The proton-rich product solution may comprise electrogenerated protic species. The electrogenerated protic species may be produced directly at an electrode of the electrochemical cell or may be produced indirectly as the result of a chemical reaction induced by one or more electrochemical reactions (e.g., a hydronium cation generated at an electrode as the result of a hydrogen oxidation half-reaction may diffuse and protonate an anion present in an anolyte, thereby forming an electrogenerated protic species). The electrogenerated protic species may be dissolved in an aqueous solution. The electrogenerated protic species may be a direct or indirect product of the one or more chemical reactions performed in the electrochemical assembly. In some, but not necessarily all embodiments, the electrogenerated protic species is a source of acidity for the solution. In some embodiments, the protic species is an electrogenerated acidic species. For example, the electrogenerated protic species may be an acidic species having a relatively low pKa. The acidic species may have a pKa of less than or equal to 7, less than or equal to 6, less than or equal to 5, less than or equal to 4, less than or equal to 3, less than or equal to 2.5, less than or equal to 2, less than or equal to 1, less than or equal to 0, less than or equal to −1, and/or as low as −1.7, as low as −2, or less in water at a temperature of 298 K. Combinations of these ranges are possible. In some embodiments, the electrogenerated acidic species comprises hydronium ions (H₃O⁺). One way in which the hydronium ions may be generated is from the hydrogen oxidation reaction (e.g., in the anolyte chamber). The protons generated by the hydrogen oxidation reaction protonate water molecules, thereby forming the hydronium ions. As another example, the electrogenerated protic species may comprise a weak acid. The weak acid may be, for example, an organic weak acid. Examples of organic weak acids include, but are not limited to acetic acid, acrylic acid, benzoic acid, chloroacetic acid, citric acid, dichloroacetic acid, formic acid, hexanoic acid, maleic acid, malic acid, malonic acid, heptanoic acid, octanoic acid, oxalic acid, phthalic acid, picric acid, succinic acid, and/or trichloroacetic acid. In some embodiments, the weak acid is an inorganic weak acid. Examples of inorganic weak acids include, but are not limited to boric acid, chromic acid, perchloric acid, periodic acid, phosphoric acid, dihydrogen phosphate (e.g., as dissolved alkali dihydrogen phosphate such as dissolved potassium dihydrogen phosphate), pyrophosphoric acid, sulfurous acid, and/or tetraboric acid.

The weak acid may be a weak Bronsted Lowry acid present in its protonated form but with a sufficiently high acidity to ultimately drive acid-base equilibria for carbon dioxide release (e.g., in a downstream process). For example, the protic species may comprise phosphoric acid (H₃PO₄). The phosphoric acid may be generated from protonation of dissolved dihydrogen phosphate by electrogenerated hydronium ions, either in the anolyte chamber or in a different component of the system. As another example, the protic species may comprise dihydrogen phosphate (H₂PO₄⁻). The dihydrogen phosphate may be generated from protonation of dissolved monohydrogen phosphate by electrogenerated hydronium ions, either in the anolyte chamber or in a different component of the system. As yet another example, the protic species may comprise boric acid (H₃BO₃). The boric acid may be generated from protonation of dissolved dihydrogen borate by electrogenerated hydronium ions, either in the anolyte chamber or in a different component of the system. As yet another example, the protic species may comprise acetic acid. The acetic acid may be generated from protonation of dissolved acetate by electrogenerated hydronium ions, either in the anolyte chamber or in a different component of the system. As yet another example, the protic species may comprise benzoic acid. The benzoic acid may be generated from protonation of dissolved benzoate by electrogenerated hydronium ions, either in the anolyte chamber or in a different component of the system. As yet another example, the protic species may comprise formic acid. The formic acid may be generated from protonation of dissolved formate by electrogenerated hydronium ions, either in the anolyte chamber or in a different component of the system.

The protic species (e.g., an acidic species such as hydronium ions) may be present in the proton-rich product solution in a relatively high concentration (which may promote effective carbon dioxide release in the electrochemical cell and/or elsewhere in the system). It should be understood that the name “proton-rich product solution” is used for convenience in identifying the solution, and is not meant to imply any particular absolute or relative concentration of protons or acid in the solution. In some embodiments, the protic species (e.g., hydronium ions) is present in the proton-rich product solution at a concentration of greater than or equal to 0.000001 M, greater than or equal to 0.00001 M, greater than or equal to 0.0001 M, greater than or equal to 0.001 M, greater than or equal to 0.01 M, greater than or equal to 0.02 M greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, the protic species (e.g., hydronium ions) is present in the proton-rich product solution at a concentration of greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.05 M and less than or equal to 3 M, greater than or equal to 0.1 and less than or equal to 2 M) are possible. Another example of a combination of these ranges is greater than or equal to 0.000001 M and less than or equal to 3 M. In some embodiments, the molar ratio of the concentration of the protic species (e.g., hydronium ions) in the proton-rich product solution to the concentration of the protic species in the aqueous input stream and/or a stream fed to the anolyte compartment (e.g., which may be the aqueous input stream itself or a different electrolyte stream) is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, the proton-rich product solution has a relatively low pH. For example, in some embodiments, the proton-rich product solution has a pH of less than or equal to 6, less than or equal to 5, less than or equal to 4, less than or equal to 3, less than or equal to 2, less than or equal to 1, less than or equal to 0, and/or as low as −1, as low as −2, or lower. Combinations of these ranges are possible. In some embodiments, the proton-rich product solution has a lower pH than the aqueous input stream and/or a stream fed to the anolyte compartment (e.g., by at least 0.05 pH units, at least 1 pH unit, at least 1.5 pH units, at least 2 pH units, at least 3 pH units, at least 4 pH units, at least 5 pH units, at least 6 pH units, and/or up to 7 pH units, up to 8 pH units, up to 9 pH units, up to 10 pH units, or more).

In some embodiments, the proton-rich product solution comprises at least some of the anions (e.g., the halide, sulfate, nitrate, and/or phosphate anions discussed above). The anions may be from the aqueous input stream. For example, the anions in the proton-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the anions in the aqueous input stream. For example, an aqueous input solution comprising dissolved MX (e.g., NaCl) may be transported to the electrochemical cell, and a proton-rich product solution comprising dissolved HX (e.g., HCl) may be produced by the electrochemical cell.

In some embodiments, carbon dioxide from at least one input gas stream is captured. As noted above, in some embodiments carbon dioxide from two or more different input gas streams from two or more different sources is captured (e.g., from a first input gas stream from a first source and from a second input gas stream from a second, different source), which may improve the efficiency of carbon dioxide capture per unit input of energy (e.g., per basic species electrochemically generated). In some embodiments, carbon dioxide from a first input gas stream from a first source is captured. The capture of the carbon dioxide may be induced by exposure of the carbon dioxide to a relatively high pH solution. For example, in some embodiments, at least some (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up 99 mol %, or all) of the electrogenerated basic species from the base-rich product solution are exposed to carbon dioxide from the first input gas stream. The specific ions/molecules of basic species (e.g., hydroxide ions) exposed to the carbon dioxide may not be literally the exact same ions/molecules of the basic species directly produced by the electrochemical reactions discussed above, as those electrogenerated ions/molecules may undergo, for example, one or more proton transfers with other species in solution to create equivalent basic species. For example, a first hydroxide ion generated at an electrode of the electrochemical cell may later deprotonate a first neutral water molecule in the base-rich product solution to generate a second hydroxide ion and a second neutral water molecule, and so the composition of the base-rich product solution would be unchanged. If the second, equivalent hydroxide ion (or a third, equivalent hydroxide ion from yet another proton transfer, and so on) then was exposed to the carbon dioxide from the first input gas stream, then that would still be considered exposure of an electrogenerated hydroxide ion to the carbon dioxide.

This exposure of electrogenerated basic species from the base-rich product solution to the carbon dioxide may result in the generation of a first carbon dioxide-lean output gas stream and a first capture stream, as discussed below. As an example, in FIG. 1A, first contact vessel liquid inlet stream 106 comprising at least a portion (e.g., at least 5 mol %, at least 10 mol %, at least 25 mol %, at least 50 mol %, at least 75 mol %, at least 90 mol %, at least 95 mol %, at least 98 mol %, at least 99 mol %, or more) of base-rich product solution 103 and first input gas stream 105 are each input into first gas-liquid contact vessel 131, where the presence of the electrogenerated basic species induces, via one or more acid-base equilibrium reactions, the removal of carbon dioxide from first input gas stream 105 to form first carbon dioxide-lean output gas stream 107 and capture stream 108.

As discussed above, generally, the acid-base equilibria driving removal of carbon dioxide via exposure of carbon dioxide to the basic species may proceed as follows:

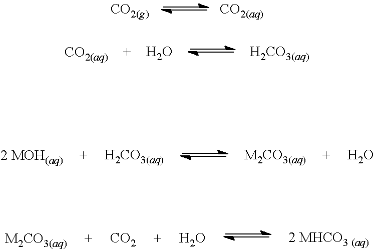

where MOH corresponds to dissolved cation and hydroxide. It should be understood that while the chemical reactions shown above include double arrows for equilibrium reactions and are referred to in various places of this disclosure as acid-base equilibria, the methods described in this disclosure may be operated under conditions such that some or all of these reactions proceed without being at chemical equilibrium (e.g., due to mass transfer of species between different phases). As noted above, the second and third reactions of the four reactions shown here may be performed effectively to completion under some conditions. In this reaction scheme, the hydroxide drives deprotonation of carbonic acid to form carbonate ions thereby converting carbon dioxide from a gas to a dissolved species in a liquid solution. Alternatively or additionally, carbonate ions (generated by the above equilibria and/or from the base-rich product solution) may drive similar equilibria to form bicarbonate ions.

Any of a variety of gas streams from any of a variety of sources may be employed as the first input gas stream. In some embodiments, at least a portion (e.g., at least 50 mol %, at least 75 mol %, at least 90 mol %, and/or up to 95 mol %, up to 98 mol %, up 99 mol %, or all) of the first input gas stream is from the first source. In some embodiments, the first input gas stream is, comprises, or is derived from air (e.g., ambient air). As such, the first source, which supplies the first input gas stream, may be ambient air. In such a way, the methods and systems of this disclosure may be used to perform direct air capture of carbon dioxide. In other embodiments, the first source is a point source of carbon dioxide (e.g., industrial effluent). While the first input gas stream may be referred to as a stream, this is not to imply any particular flow rate or type of flow path for the stream. For example, the system may intake gas (e.g., ambient air) surrounding the system, and/or gas may be flowed (e.g., at ambient or an elevated pressure) through a conduit into, for example, a first gas-liquid contact vessel.

In some embodiments, the first input gas stream comprises carbon dioxide in an amount of less than or equal to 100,000 ppm, less than or equal to 50,000 ppm, less than or equal to 20,000 ppm, less than or equal to 10,000 ppm, less than or equal to 5,000 ppm, less than or equal to 2,000 ppm, less than or equal to 1,000 ppm, less than or equal to 600 ppm, less than or equal to 500 ppm, and/or as low as 400 ppm, as low as 300 ppm, as low as 250 ppm, or less on a molar basis. Combinations of these ranges (e.g., less than or equal to 100,000 ppm and as low as 250 ppm, or less than or equal to 1,000 ppm and as low as 250 ppm on a molar basis) are possible.

In some embodiments, the first input gas stream comprises carbon dioxide at a partial pressure of less than or equal to 0.5 bar, less than or equal to 0.2 bar, less than or equal to 0.1 bar, less than or equal to 0.05 bar, less than or equal to 0.02 bar, less than or equal to 0.01 bar, less than or equal to 0.005 bar, less than or equal to 0.002 bar, less than or equal to 0.001 bar, and/or as low as 0.0005 bar, as low as 0.0002 bar, as low as 0.0001 bar, or less. Combinations of these ranges (e.g., less than or equal to 0.5 bar and as low as 0.0001 bar) are possible.

As noted above, the interaction between the carbon dioxide and the basic species (e.g., via one or more acid-base equilibrium reactions) may produce a first carbon dioxide-lean output gas stream. For example, in FIG. 1A, first carbon dioxide-lean output gas stream 107 may be output from first contact vessel gas outlet 132 of first gas-liquid contact vessel 131. The first carbon dioxide-lean output gas stream may have a relatively low concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the first carbon dioxide-lean output gas stream comprises carbon dioxide in an amount of less than or equal to 50,000 ppm, less than or equal to 25,000 ppm, less than or equal to 10,000 ppm, less than or equal to 5,000 ppm, less than or equal to 2,500 ppm, less than or equal to 1,000 ppm, less than or equal to 600 ppm, less than or equal to 500 ppm, less than or equal to 400 ppm, less than or equal to 300 ppm, less than or equal to 200 ppm, less than or equal to 100 ppm, less than or equal to 50 ppm, less than or equal to 20 ppm, less than or equal to 10 ppm, less than or equal to 5 ppm, less than or equal to 1 ppm, and/or as low as 0.5 ppm, as low as 0.1 ppm, as low as 0.01 ppm, or less on a molar basis. Combinations of these ranges (e.g., greater than or equal to 0.01 ppm and less than or equal to 50,000 ppm, or greater than or equal to 1 ppm and less than or equal to 2.500 ppm on a molar basis) are possible.

The first carbon dioxide-lean output gas stream may have a lower concentration of carbon dioxide than the first input gas stream. In some embodiments, a relatively high percentage of carbon dioxide in the first input gas stream is removed in forming the first carbon dioxide-lean output gas stream. For example, in some embodiments, a molar ratio of the concentration of carbon dioxide in the first input gas stream to the concentration of carbon dioxide in the first carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible. In some embodiments, a ratio of the number of moles of carbon dioxide in the first input gas stream to the number of moles of carbon dioxide in the first carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible.

In some embodiments, the first carbon dioxide-lean output gas stream is discharged from the system. However, in other embodiments, the first carbon dioxide-lean output gas stream is transported to a different component of the system for further treatment (e.g., removal of additional contaminants and/or combination with other streams).

In some embodiments, the interaction between the carbon dioxide and the basic species (e.g., via one or more acid-base equilibrium reactions) produces a first capture stream. For example, in FIG. 1A, first capture stream 108 may be output from first contact vessel liquid outlet 133 of first gas-liquid contact vessel 131. The first capture stream may comprise captured carbon dioxide in the form of, for example, dissolved carbonate anions formed from carbon dioxide from the first input gas stream (e.g., upon exposure to electrogenerated alkalinity in the form of basic species). The first capture stream may have a relatively high concentration of dissolved carbonate anions. For example, in some embodiments, the first capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of carbonate anions while the first capture stream comprises carbonate anions. In some embodiments in which the base-rich product solution comprises carbonate anions, the molar ratio of the concentration of carbonate anions in the first capture stream to the concentration of carbonate anions in the stream to which the carbon dioxide is exposed (e.g., the first contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments, the first capture stream comprises dissolved bicarbonate anions. The bicarbonate anions may be formed from the carbon dioxide from the first input gas stream. The first capture stream may have a relatively low concentration of dissolved bicarbonate anions. For example, in some embodiments, the first capture stream comprises dissolved bicarbonate anions at a concentration of less than or equal to 0.5 M, less than or equal to 0.2 M, less than or equal to 0.1 M, less than or equal to 0.01 M, less than or equal to 0.001 M, less than or equal to 0.0001M, and/or as low as 0.00001 M, less than or equal to 0.000001 M, or less. The first capture stream may have a relatively high concentration of dissolved bicarbonate anions. For example, in some embodiments, the first capture stream comprises dissolved bicarbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of bicarbonate anions while the first capture stream comprises bicarbonate anions. In some embodiments in which the base-rich product solution comprises bicarbonate anions, the molar ratio of the concentration of bicarbonate anions in the first capture stream to the concentration of bicarbonate anions in the stream to which the carbon dioxide is exposed (e.g., the first contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments, first capture stream has a relatively high pH. For example, in some embodiments, the first capture stream has a pH of greater than or equal to 7, greater than or equal to 8, greater than or equal to 9, greater than or equal to 10, greater than or equal to 11, greater than or equal to 12, and/or up to 13, up to 14, or greater. Combinations of these ranges are possible.

In some embodiments, the first capture stream comprises at least some of the dissolved cations (e.g., the metal cations and/or ammonium cations discussed above). The cations may be from the base-rich product solution. For example, the cations in the first capture stream may constitute at least a portion (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up to 99 mol %, or all) of the cations in the base-rich product solution. For example, a first contact vessel inlet stream comprising dissolved MOH (e.g., NaOH) may be transported to the first gas-liquid contact vessel, and a first capture stream comprising dissolved M₂CO₃ (e.g., Na₂CO₃) and, in some instances, dissolved MHCO₃ (e.g., NaHCO₃) may be produced by the first gas-liquid contact vessel upon interaction (e.g., contacting and/or mixing) with the first input gas stream. In some embodiments, the first capture stream is transported to a different component of the system for further treatment (e.g., exposure to additional carbon dioxide from a second input gas stream from a second, different source).

In some embodiments, carbon dioxide from a second input gas stream from a second source is captured. For example, in some embodiments, at least some (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up 99 mol %, or all) of the first capture stream is exposed to carbon dioxide from the second input gas stream. This exposure of at least a portion of the first capture stream to the carbon dioxide from the second input gas stream may result in the generation of a second carbon dioxide-lean output gas stream and a second capture stream, as discussed below. As an example, in FIG. 1A, at least a portion of first capture stream 108 exiting first contact vessel liquid outlet 133 is transported to second contact vessel liquid inlet 140 of second gas-liquid contact vessel 134, while second input gas stream 109 is transported to second contact vessel gas inlet 149 of second gas-liquid contact vessel 134, such that each is input into second gas-liquid contact vessel 134. In second gas-liquid contact vessel 134, the presence of basic species such as carbonate anions and/or hydroxide ions induces, via one or more acid-base equilibrium reactions, the removal of carbon dioxide from second input gas stream 109 to form second carbon dioxide-lean output gas stream 110 exiting second contact vessel gas outlet 135 and second capture stream 111.

In some embodiments, the temperature of the at least a portion of the first capture stream exiting the first contact vessel is increased prior to being exposed to carbon dioxide from the second input gas stream and/or reaching the second contact vessel liquid inlet. For example, the first capture stream may be heated (e.g., by a heating element such as a heater and/or a heat exchanger). The temperature of the first capture stream that is first exposed to carbon dioxide from the second input gas stream and/or reaches the second contact vessel liquid inlet may be greater than the initial temperature of the first capture stream (e.g., exiting the liquid outlet of the first gas-liquid contact vessel) by at least 10 degrees C., at least 20 degrees C., at least 30 degrees C., and/or up to 50 degrees C., or more. The increasing of the temperature of the first capture stream may promote faster and/or more efficient capture of carbon dioxide in the second gas-liquid contact vessel and/or prevent deleterious phenomena that may occur at relatively lower temperatures.

In some embodiments, the exposure of carbonate anions present in the first capture stream exposed to the carbon dioxide from the second input gas stream results in a reaction that generates bicarbonate anions. For example, in some embodiments, the following net chemical reaction occurs as a result of the exposure of carbonate anions from the first capture stream to carbon dioxide from the second input gas stream:

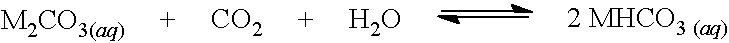

The above reaction could occur, for example, by the transient formation of carbonic acid (H₂CO₃) from the CO₂ and the H₂O, followed by deprotonation of the carbonic acid coupled to protonation of the carbonate, leading to two equivalents of bicarbonate anions. As noted above, the distribution of products when the reaction is at equilibrium is affected by the concentration (or partial pressure or fugacity) of the carbon dioxide, with a larger concentration of carbon dioxide pushing the equilibrium to the right and leading to a greater extent of generation of bicarbonate anions. Also as noted above, a greater extent of generation of bicarbonate anions is associated with a greater overall capture efficiency of carbon dioxide for a given amount of input into the system (e.g., electrical energy and/or reagents).

Any of a variety of gas streams from any of a variety of sources may be employed as the second input gas stream. In some embodiments, at least a portion (e.g., at least 50 mol %, at least 75 mol %, at least 90 mol %, and/or up to 95 mol %, up to 98 mol %, up 99 mol %, or all) of the second input gas stream is from the second source. In some embodiments, the second input gas stream is, comprises, or is derived from industrial effluent. For example, the second input gas stream may comprise or be derived from flue gas. As noted above, the second source, which supplies at least a portion of the second input gas stream, may be different than the first source that supplies the first input gas stream. In some embodiments, the second source is a point source of carbon dioxide. A point source of carbon dioxide is a single location (e.g., a power plant, factory, and/or industrial facility) that emits carbon dioxide, as opposed to diffuse, atmospheric carbon dioxide present in ambient air. In such a way, the methods and systems of this disclosure may be used to perform direct carbon capture. In some embodiments, the point source comprises a power plant, a cement production facility, a steel production facility, an aluminum production facility, a steam methane reforming facility, an autothermal reforming facility, a natural gas wellhead, a natural gas pipeline, a paper mill, and/or a Haber-Bosch facility (which catalytically produces NH₃ from H₂ and N₂).

In some embodiments, the second input gas stream is free of gas from the first source or comprises gas from the first source in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. In some embodiments, the second input gas stream is free of carbon dioxide from the first source or comprises carbon dioxide from the first source in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. In some embodiments, the second input gas stream is free of ambient air or comprises ambient air in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. However, in some embodiments, the second input gas stream comprises ambient air and/or a component from ambient air such as nitrogen gas.

In some embodiments, the first source is ambient air and the second source is a point source.

While the second input gas stream may be referred to as a stream, this is not to imply any particular flow rate or type of flow path for the stream.

In some embodiments, the second input gas stream comprises carbon dioxide at a concentration of greater than or equal to 0.2 mol %, greater than or equal to 0.5 mol %, greater than or equal to 1 mol %, greater than or equal to 2 mol %, greater than or equal to 5 mol %, greater than or equal to 10 mol %, and/or up to 20 mol %, up to 30 mol %, up to 40 mol %, up to 50 mol %, or greater. Combinations of these ranges (e.g., greater than or equal to 0.2 mol % and less than or equal to 50 mol %) are possible.

In some embodiments, the second input gas stream comprises carbon dioxide at a partial pressure of greater than or equal to 0.002 bar, greater than or equal to 0.005 bar, greater than or equal to 0.01 bar, greater than or equal to 0.02 bar, greater than or equal to 0.05 bar, greater than or equal to 0.1 bar, greater than or equal to 0.2 bar, greater than or equal to 0.5 bar, greater than or equal to 1 bar, greater than or equal to 2 bar, greater than or equal to 5 bar, greater than or equal to 10 bar, and/or up to 20 bar, up to 30 bar, up to 40 bar, or more. Combinations of these ranges (e.g., greater than or equal to 0.002 bar and less than or equal to 40 bar) are possible.

In some embodiments, the second input gas stream comprises carbon dioxide at a higher concentration than the first input gas stream. For example, in some embodiments, a molar ratio of the concentration of carbon dioxide in the second input gas stream to the concentration of carbon dioxide in the first input gas stream is greater than or equal to 2, greater than or equal to 5, greater than or equal to 10, greater than or equal to 20, greater than or equal to 50, greater than or equal to 100, greater than or equal to 200, greater than or equal to 500, and/or up to 1,000, up to 1,500, up to 2,000, or greater. Combinations of these ranges (e.g., greater than or equal to 2 and less than or equal to 2,000) are possible.

In some embodiments, the second input gas stream comprises carbon dioxide at a higher partial pressure than the partial pressure of carbon dioxide in the first input gas stream. In some embodiments, the second input gas stream comprises carbon dioxide at a higher partial pressure than a partial pressure of carbon dioxide in the first input gas stream by greater than or equal to 0.001 bar, greater than or equal to 0.01 bar, greater than or equal to 0.1 bar, greater than or equal to 0.2 bar, greater than or equal to 0.5 bar, greater than or equal to 1 bar, greater than or equal to 2 bar, greater than or equal to 5 bar, greater than or equal to 10 bar, greater than or equal to 20 bar, greater than or equal to 30 bar, and/or up to bar, or more. Combinations of these ranges are possible. In some embodiments, a ratio of the partial pressure of carbon dioxide in the second input gas stream to the partial pressure of carbon dioxide in the first input gas stream is greater than or equal to 2, greater than or equal to 5, greater than or equal to 10, greater than or equal to 20, greater than or equal to 50, greater than or equal to 100, greater than or equal to 200, greater than or equal to 500, and/or up to 1,000, up to 1,500, up to 2,000, or greater. Combinations of these ranges (e.g., greater than or equal to 2 and less than or equal to 2,000) are possible.

As noted above, the interaction between the carbon dioxide from the second input gas stream and the carbonate anions from the first capture stream (e.g., via one or more acid-base equilibrium reactions) may produce a second carbon dioxide-lean output gas stream. For example, in FIG. 1A, second carbon dioxide-lean output gas stream 110 may be output from second contact vessel gas outlet 135 of second gas-liquid contact vessel 134. The second carbon dioxide-lean output gas stream may have a relatively low concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the second carbon dioxide-lean output gas stream comprises carbon dioxide in an amount of less than or equal to 25 mol %, less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.05 mol %, less than or equal to 0.02 mol %, and/or as low as 0.01 mol %, as low as 0.001 mol %, or less. Combinations of these ranges are possible.

The second carbon dioxide-lean output gas stream may have a lower concentration of carbon dioxide than the second input gas stream. In some embodiments, a relatively high percentage of carbon dioxide in the second input gas stream is removed in forming the second carbon dioxide-lean output gas stream. For example, in some embodiments, a molar ratio of the concentration of carbon dioxide in the second input gas stream to the concentration of carbon dioxide in the second carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible. In some embodiments, a ratio of the number of moles of carbon dioxide in the second input gas stream to the number of moles of carbon dioxide in the second carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible.

In some embodiments, the second carbon dioxide-lean output gas stream is discharged from the system. However, in other embodiments, the second carbon dioxide-lean output gas stream is transported to a different component of the system for further treatment (e.g., removal of additional contaminants and/or combination with other streams).

In some embodiments, the interaction between the carbon dioxide from the second input gas stream and the carbonate anions from the first capture stream (e.g., via one or more acid-base equilibrium reactions) produces a second capture stream. For example, in FIG. 1A, second capture stream 111 may be output from second contact vessel liquid outlet 136 of second gas-liquid contact vessel 134. The second capture stream may comprise captured carbon dioxide in the form of, for example, dissolved bicarbonate anions, at least some of which are formed from carbon dioxide from the second input gas stream (e.g., upon exposure of carbonate anions from the first capture stream to carbon dioxide from the second input gas stream).

In some embodiments, the second capture stream comprises dissolved bicarbonate anions. At least some (e.g., at least 1 mol %, at least 2 mol %, at least 5 mol %, at least 10 mol %, at least 25 mol %, at least 40 mol %, at least 50 mol %, at least 75 mol %, at least 90 mol %, at least 95 mol %, at least 98 mol %, at least 99 mol %, at least 99.9 mol %, or all) of the bicarbonate anions in the second capture stream are generated from carbonate anions from the first capture stream by the reaction resulting from exposure of the at least a portion of the first capture stream to carbon dioxide from the second input gas stream (e.g., as discussed above). However, in some embodiments, not all bicarbonate anions in the second capture stream are generated from carbonate anions from the first capture stream. In some embodiments, less than or equal to 99.9 mol %, less than or equal to 99 mol %, less than or equal to 98 mol %, less than or equal to 95 mol %, less than or equal to 90 mol %, less than or equal to 75%, or less of the bicarbonate anions in the second capture stream are generated from carbonate anions from the first capture stream by the reaction resulting from exposure of the at least some of the first capture stream to carbon dioxide from the second input gas stream. Combinations of these ranges are possible.

In some, but not necessarily all embodiments, the first capture stream comprises residual basic species. For example, the first capture stream may comprise residual hydroxide ions. The residual basic species may be present in the first capture stream due to incomplete reaction between the basic species and the carbon dioxide from the first input gas stream (e.g., due to a stoichiometric excess of basic species, thermodynamic conditions, and/or kinetic conditions). In some embodiments, at least some (e.g., at least 1 mol %, at least 2 mol %, at least 5 mol %, at least 10 mol %, at least 25 mol %, at least 40 mol %, at least 50 mol %, at least 75 mol %, at least 90 mol %, at least 95 mol %, at least 98 mol %, at least 99 mol %, at least 99.9 mol %, or all) of the bicarbonate anions in the second capture stream are generated due the presence of residual basic species (e.g., hydroxide ions) from the first capture stream during the exposure of the at least some of the first capture stream to carbon dioxide from the second input gas stream (e.g., as discussed above).

It has been realized that the methods of this disclosure can, in some instances, obviate the need for full reaction of all basic species (e.g., hydroxide ions) to generate carbonate anions during the exposure of the basic species to the carbon dioxide from the first input gas stream (e.g., in the first gas-liquid contact vessel, such as a Direct Air Capture contactor) when looking to promote efficiency. With techniques other than those described in this disclosure, it is generally believed that high conversion of basic species is quite important because any basic species (e.g., hydroxide ions) not used in carbon capture are eventually neutralized in a downstream process (e.g., recombination with acid), resulting in a loss of efficiency. However, full conversion of basic species (e.g., when exposed to low concentrations of carbon dioxide such as in Direct Air Capture) can be kinetically challenging. Accordingly, the methods of this disclosure may promote efficient carbon dioxide capture without, in some instances, reacting all basic species with carbon dioxide from the first input gas stream. Instead, unreacted basic species may later participate in the reactions that generate bicarbonate (e.g., upon exposure of the first capture stream to carbon dioxide from the second input gas stream).

The second capture stream may have a relatively high concentration of dissolved bicarbonate anions. For example, in some embodiments, the second capture stream comprises dissolved bicarbonate anions at a concentration of greater than or equal to 0.1 M, greater than or equal to 0.2 M, greater than or equal to 0.5 M, greater than or equal to 1 M. and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible.

In some embodiments, the concentration of bicarbonate anions in the second capture stream is greater than a concentration of bicarbonate anions in the first capture stream. In some, but not necessarily all embodiments, the first capture stream is free of bicarbonate anions while the second capture stream comprises bicarbonate anions. In some embodiments in which the first capture stream comprises bicarbonate anions, the molar ratio of the concentration of bicarbonate anions in the second capture stream to the concentration of bicarbonate anions in the first capture stream is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments in which carbonate anions and bicarbonate anions are both present in both the first capture stream and the second capture stream, the ratio of bicarbonate anions to carbonate anions in the second capture stream is greater than the ratio of bicarbonate anions to carbonate anions in the first capture stream. This change in ratio may be due to some or all of the carbonate anions from the first capture stream being converted to bicarbonate anions in the second capture stream due to the reaction induced by the presence of additional carbon dioxide from the second input gas stream. In some embodiments, the molar ratio of the concentration of bicarbonate anions in the second capture stream to the concentration of carbonate anions in the second capture stream is greater than the molar ratio of the concentration of bicarbonate anions in the first capture stream to the concentration of carbonate anions in the first capture stream (e.g., by a factor of at least 1.01, at least 1.02, at least 1.05, at least 1.1, at least 1.2, at least, 1.5, at least 2, at least 5, at least 10, at least 20, and/or up to 50, up to 100, or more).

In some, but not necessarily all embodiments, the second capture stream may have a relatively high concentration of dissolved carbonate anions. For example, in some embodiments, the second capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible.

In some embodiments, second capture stream has a relatively high pH. For example, in some embodiments, the second capture stream has a pH of greater than or equal to 5, greater than or equal to 6, greater than or equal to 7, greater than or equal to 8, greater than or equal to 9, greater than or equal to 10, greater than or equal to 11, greater than or equal to 12, and/or up to 13, up to 14, or greater. Combinations of these ranges are possible. In some embodiments, the second capture stream has a lower pH than the first captures stream (e.g., by at least 0.05 pH units, by at least 1 pH, by at least 2 pH units, by at least 3 pH units, or more).

In some embodiments, the second capture stream comprises at least some of the dissolved cations (e.g., the metal cations and/or ammonium cations discussed above). The cations may be from the base-rich product solution. For example, the cations in the second capture stream may constitute at least a portion (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up to 99 mol %, or all) of the cations in the base-rich product solution. In some embodiments, the cations may also be from the first captures stream. For example, a first capture stream comprising dissolved M₂CO₃ may be transported to the second gas-liquid contact vessel, and a second capture stream comprising dissolved MHCO₃ (e.g., NaHCO₃) may be produced by the second gas-liquid contact vessel upon interaction (e.g., contacting and/or mixing) with the second input gas stream.

In some embodiments, the second capture stream is discharged from the system. However, in other embodiments, the second capture stream is transported to a different component of the system for further treatment (e.g., exposure to acidic species to promote release of gaseous carbon dioxide).

In some embodiments, the method is performed with a relatively low basic species carbon efficiency number (E_{B}). In some embodiments, the method is performed with a basic species carbon efficiency number (E_{B}) that is less than or equal to 1.9, less than or equal to 1.8, less than or equal to 1.7, less than or equal to 1.6, less than or equal to 1.5, less than or equal to 1.4, less than or equal to 1.3, less than or equal to 1.2, less than or equal to 1.1, less than or equal to 1.05, and/or as low as 1.02, as low as 1.01, or lower (e.g., 1.00). Combinations of these ranges (less than or equal to 1.9 and as low as 1, or less than or equal to 1.6 and as low as 1, or less than or equal to 1.5 and as low as 1) are possible. The basic species carbon efficiency number (E_{B}) is defined as:

$${E}_{B} = 1 + \frac{{[ {CO}_{3}^{2 -} ]}_{s e c o n d}}{{[ {CO}_{3}^{2 -} ]}_{s e c o n d} + {[ {HCO}_{3}^{-} ]}_{s e c o n d}}$$

where

$${[ {CO}_{3}^{2 -} ]}_{s e c o n d}$$

is a molar concentration of carbonate anions in the second capture stream, and where

$${[ {HCO}_{3}^{-} ]}_{s e c o n d}$$

is a molar on concentration of bicarbonate anions in the second capture stream. A low basic species carbon efficiency number is associated with a more efficient process with respect to capture of carbon dioxide per basic species generated. In some embodiments, use of a second input gas stream (from a second source) having a relatively high concentration of carbon dioxide can contribute at least in part to the process having a relatively low basic species carbon efficiency number.

In some embodiments, the system for at least partially separating carbon dioxide from a gas stream comprises one or more gas-liquid contact vessels. The gas-liquid contact vessels may be configured to expose carbon dioxide from a gas input stream to a liquid solution capable of capturing the carbon dioxide (e.g., via dissolution and/or conversion to another species such as carbonate and/or bicarbonate).

In some embodiments, the electrogenerated basic species from the base-rich product solution and the carbon dioxide from the first input gas stream are exposed to each other in a first gas-liquid contact vessel. In the first gas-liquid contact vessel, at least a portion of the base-rich product solution may be contacted with the first input gas stream. For example, in FIG. 1A, first gas-liquid contact vessel 131 receives (a) first input gas stream 105 comprising carbon dioxide via first contact vessel gas inlet 142 and (b) first contact vessel liquid inlet stream 106 via first contact vessel liquid inlet 145, in accordance with some embodiments. First contact vessel liquid inlet stream 106 comprises at least a portion of base-rich product stream 103 comprising electrogenerated basic species, such that the basic species (e.g., hydroxide ions) can interact with the carbon dioxide as described above. In some embodiments, at least a portion of the base-rich product solution is transported from the electrochemical assembly to the first gas-liquid contact vessel by forming at least a portion of the first contact vessel liquid inlet stream (e.g., via a fluidic connection between the first electrochemical assembly liquid outlet and the first contact vessel liquid inlet). The first input gas stream may be transported to the first gas-liquid contact vessel via the first contact vessel gas inlet. In some embodiments, the first gas-liquid contact vessel is separate from the electrochemical assembly (e.g., separate from the electrochemical cell). This may permit the interaction between the carbon dioxide from the first input gas stream and the electrogenerated basic species to occur in a location separate from the electrochemical assembly (e.g., after expulsion of basic species from the electrochemical assembly).

In some embodiments, the at least a portion of the first capture stream and the carbon dioxide from the second input gas stream are exposed to each other in a second gas-liquid contact vessel. In the second gas-liquid contact vessel, at least a portion of the first capture stream may be contacted with the second input gas stream. For example, in FIG. 1A, second gas-liquid contact vessel 134 receives (a) second input gas stream 109 comprising carbon dioxide via second contact vessel gas inlet 149 and (b) at least a portion of first capture stream 108 via second contact vessel liquid inlet 140, in accordance with some embodiments. First capture stream 108 comprises dissolved carbonate anions formed from captured carbon dioxide from first input gas stream 105, such that the carbonate anions in solution can participate in a chemical reaction that generates bicarbonate anions from carbon dioxide from second input gas stream 109 as described above. In some embodiments, at least a portion of the first capture stream is transported from the first gas-liquid contact vessel to the second gas-liquid contact vessel via a fluidic connection between the first contact vessel liquid outlet and the second contact vessel liquid inlet. In some embodiments, the second gas-liquid contact vessel is separate from the electrochemical assembly (e.g., separate from the electrochemical cell). This may permit the interaction between the carbon dioxide from the second input gas stream and the components of the first capture stream (e.g., carbonate anions) to occur in a location separate from the electrochemical assembly (e.g., after expulsion of basic species from the electrochemical assembly).

Any of a variety of gas-liquid contact vessels may be employed for the first gas-liquid contact vessel and/or the second gas-liquid contact vessel. The first gas-liquid contact vessel and/or the second gas-liquid contact vessel may each comprise a gas-liquid contactor configured to promote mass and in some instances heat transfer between gas-phase species and liquid-phase species. In some embodiments, the first gas-liquid contact vessel and/or the second gas-liquid contact vessel comprises a differential gas-liquid contactor. In other embodiments, the first gas-liquid contact vessel and/or the second gas-liquid contact vessel comprises a stepwise gas-liquid contactor. Examples of types of gas-liquid contact vessels that may be independently suitable for the first gas-liquid contact vessel and/or the second gas-liquid contact vessel include, but are not limited to bubble columns, spray towers, cooling towers, packed columns, agitated vessels, plate columns, rotating disc contactors, Venturi tubes, hollow fiber gas-liquid contactors, absorption columns, desorption columns, and/or stripping columns. In some embodiments, the first gas-liquid contact vessel and/or the second gas-liquid contact vessel comprises an interior volume in fluid communication with its respective contact vessel gas inlet and contact vessel liquid inlet. The interior volume may permit contact between the respective input gas stream and contact vessel inlet liquid stream. Contact between carbon dioxide from the respective input gas stream and liquid from the respective inlet liquid stream may result in the dissolution of at least some of the gaseous carbon dioxide. The carbon dioxide may then undergo the acid-base equilibria described above.

While FIG. 1A shows first gas-liquid contact vessel 131 and second gas-liquid contact vessel 134 as being physically separated (e.g., by an external conduit for transporting first capture stream 108), in other embodiments the first gas-liquid contact vessel and the second gas-liquid contact vessel can be housed within the same exterior shell (e.g., as two separate stages of gas-liquid contactors within a single unit, but configured to receive the respective different first input gas stream and second input gas streams at least partially formed from the different first and second sources).

In some, but not necessarily all embodiments, the second gas-liquid contact vessel is a different type of gas-liquid contact vessel than the first gas-liquid contact vessel. In some embodiments, the first gas-liquid contact vessel is configured to capture carbon dioxide from an input gas stream at a first concentration and/or partial pressure of carbon dioxide, and the second gas-liquid contact vessel is configured to capture carbon dioxide from an input gas stream at a second, different (e.g., higher) concentration and/or partial pressure of carbon dioxide. Such different configurations may be based on, for example, the surface areas of sorbent (e.g., liquid) exposed to gas streams, density of materials, overall size of the contact vessels, pressure, pressure drop, packing material/structure, aspect ratio of the contact vessel, total fluid (liquid and gas) flow, source pressure, and/or material of construction. In some embodiments, the first gas-liquid contact vessel is configured to perform direct air capture of carbon dioxide and the second gas-liquid contact vessel is configured to perform point source capture of carbon dioxide. In some embodiments, the second gas-liquid contact vessel comprises a spray tower, a vessel comprising structured packing, and/or a vessel comprising at least one sieve tray. These types of gas-liquid contact vessels may be particularly suitable for capturing carbon dioxide from input gas streams comprising relatively high concentrations and/or partial pressures of carbon dioxide (e.g., from point sources). In some embodiments, the first gas-liquid contact vessel and the second gas-liquid contact vessel are the same type of gas-liquid contact vessel but are of different size and/or capture capacity and/or are configured with different operational parameters.

In some embodiments, the captured carbon dioxide (e.g., in the form of bicarbonate and/or carbonate anions) is released to form gaseous carbon dioxide. For example, in some embodiments, at least some of the dissolved bicarbonate anions (and in some instances dissolved carbonate anions) in (or from) the second capture stream are exposed to at least some of the electrogenerated protic species. In some such embodiments, at least a portion of the second capture stream is exposed to at least some of the electrogenerated protic species (e.g., via mixing or contacting). The protic species may cause a drop in pH and drive acid-base equilibria in the opposite direction as during the capture process described above, protonating bicarbonate to form carbonic acid, which converts to dissolved carbon dioxide, which may leave the resulting solution as gaseous carbon dioxide (e.g., via desorption).

As such, in some embodiments, the exposure of the protic species formed directly or indirectly from the electrical potential difference-induced reaction(s) in the electrochemical assembly to the dissolved bicarbonate anions (and in some instances carbonate anions) in the second capture stream may generate a carbon dioxide-rich output gas stream and a release stream. It has been realized in the context of this disclosure that employing electrogenerated protic species (e.g., generated from the same electrochemical process that generated the basic species that induced the carbon dioxide capture) is more energetically efficient than employing other techniques for releasing the captured carbon dioxide, such as thermal techniques and/or breaking up carbamate bonds and/or strong ionic species such as calcium carbonate. In fact, it has been realized in the context of this disclosure that employing electrogenerated protic species is more energetically efficient than employing other techniques for releasing the captured carbon dioxide, such as thermal techniques and/or breaking covalent bonds or ionic bonds more generally. Further, it has also been realized in the context of this disclosure that the methods of this disclosure (e.g., involving electrochemical production of basic species) do not necessarily require heat integration to account for side reactions with the capture agent (e.g., liquid solution comprising basic species). Further, it has also been realized in the context of this disclosure that the methods of this disclosure (e.g., involving electrochemical production of basic species) permit use of renewable electricity to power the process in at least some embodiments. Further, it has also been realized in the context of this disclosure that the methods of this disclosure (e.g., involving electrochemical production of basic species) permit a continuous process.

As noted above, the interaction between the protic species and the dissolved bicarbonate and/or carbonate anions in (or from) the second capture stream (e.g., via one or more acid-base equilibrium reactions) may produce a carbon dioxide-rich output gas stream. For example, in FIG. 3A, carbon dioxide-rich output gas stream 115 may be generated upon combination of at least a portion of second capture stream 111 and at least a portion of proton-rich product solution 104 output from electrochemical assembly 101. While FIG. 3A shows this combination of protic species and the second capture stream occurring external to the electrochemical assembly, in other embodiments, the proton-rich product solution may be exposed to the bicarbonate anions (and in some instances carbonate anions) within the electrochemical assembly, such as within the anolyte chamber itself.

The carbon dioxide-rich output gas stream may have a relatively high concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the carbon dioxide-rich gas outlet stream comprises carbon dioxide in an amount of greater than or equal to 100,000 ppm, greater than or equal to 200,000 ppm, greater than or equal to 500,000 ppm, and/or up to 600,000 ppm, up to 700,000 ppm, up to 800,000 ppm, up to 900,000 ppm, up to 950,000 ppm, up to 980,000 ppm, up to 990,000 ppm, up to 999,000 ppm or more (e.g., pure carbon dioxide gas) on a molar basis. Combinations of these ranges are possible.

The carbon dioxide-rich output gas stream may have a higher concentration of carbon dioxide than the first input gas stream. For example, in some embodiments, a molar ratio of the concentration of carbon dioxide in the carbon dioxide-rich output gas stream to the concentration of carbon dioxide in the first input gas stream is at least 2, at least 2.5, at least 5, at least 10, at least 50, at least 100, at least 1000, at least 10,000, at least 100,000, and/or up to 1,000,000, up to 10,000,000, up to 100,000,000, or more. Combinations of these ranges are possible. The carbon dioxide-rich output gas stream may have a higher concentration of carbon dioxide than the second input gas stream. For example, in some embodiments, a molar ratio of the concentration of carbon dioxide in the carbon dioxide-rich output gas stream to the concentration of carbon dioxide in the second input gas stream is at least 2, at least 2.5, at least 5, at least 10, at least 50, at least 100, at least 1000, at least 10,000, at least 100,000, and/or up to 1,000,000, up to 10,000,000, up to 100,000,000, or more. Combinations of these ranges are possible.

The carbon dioxide-rich output gas stream may comprise moisture. For example, in some embodiments, the carbon dioxide-rich output gas stream has a moisture content of greater than or equal to 0.001%, greater than or equal to 0.01%, greater than or equal to 0.1%, and/or up to 0.5%, up to 1% or more by weight. In some embodiments, the carbon dioxide-rich output gas stream has a moisture content of greater than or equal to 0.001%, greater than or equal to 0.01%, greater than or equal to 0.1%, greater than or equal to 0.5%, greater than or equal to 1%, and/or up to 5%, up to 10%, or more by weight.

In some embodiments, at least a portion (e.g., at least 10 mol %, at least 25 mol %, at least 50 mol %, at least 75 mol %, at least 90 mol %, at least 95 mol %, at least 98 mol %, at least 99 mol %, or more) of the carbon dioxide-rich output gas stream is discharged from the system. The discharged carbon dioxide-rich stream may be used to, for example, sequester the carbon dioxide and/or to employ the carbon dioxide as a reagent for further processing (e.g., to generate fuels, plastics, commodity chemicals, and/or specialty chemicals). However, in some embodiments, at least a portion of the carbon dioxide-rich output gas stream is transferred to one or more other components of the system (e.g., for further processing).

In addition to the carbon dioxide-rich output gas stream, the interaction between the protic species and the dissolved bicarbonate anions (and in some instances, carbonate anions) in the second capture stream may produce a release stream. For example, in FIGS. 3A-3B, release stream 117 may be produced upon mixture of at least a portion of proton-rich product solution 104 and at least a portion of second capture stream 111. The release stream may comprise an aqueous solution of dissolved ions. For example, in some embodiments, the release stream comprises at least some of the dissolved cations and at least some of the anions (e.g., originally from the aqueous input stream). For example, the proton-rich product solution may comprise dissolved HCl (thereby comprising dissolved chloride ions), while the second capture stream may comprise dissolved NaHCO₃ (thereby comprising dissolved sodium ions). Upon release of CO₂ gas (e.g., in the carbon dioxide-rich output gas stream), the resulting release stream may comprise dissolved NaCl (thereby comprising dissolved sodium ions and dissolved chloride ions).

The dissolved cations (e.g., metal cations and/or ammonium cations described above) may be present in the release stream in a relatively high concentration. In some embodiments, the dissolved cations are present in the release stream at a concentration of greater than or equal to 0.05 M, greater than or equal to 0.1 M, greater than or equal to 0.2 M, greater than or equal to 0.5 M, greater than or equal to 1 M, greater than or equal to 1.5 M, up to 2 M, up to 3 M, up to 5 M, up to 10 M, or greater. Combinations of these ranges (e.g., greater than or equal to 0.05 M and less than or equal to 10 M, greater than or equal to 0.5 M and less than or equal to 3 M) are possible. The anions (e.g., non-hydroxide anions described above) may be present in the release stream in a relatively high concentration. In some embodiments, the dissolved anions (e.g., non-hydroxide anions) are present in the release stream at a concentration of greater than or equal to 0.05 M, greater than or equal to 0.1 M, greater than or equal to 0.2 M, greater than or equal to 0.5 M, greater than or equal to 1 M, greater than or equal to 1.5 M, up to 2 M, up to 3 M, up to 5 M, up to 10 M, or greater. Combinations of these ranges (e.g., greater than or equal to 0.05 M and less than or equal to 10 M, greater than or equal to 0.5 M and less than or equal to 3 M) are possible.

Due to the release of the captured carbon dioxide, the release stream may comprise bicarbonate anions and/or carbonate anions in a lower concentration than in the second capture stream. For example, in some embodiments, the molar ratio of the concentration of bicarbonate anions in the second capture stream to the concentration of bicarbonate anions in the release stream is at least 1.005, at least 1.01, at least 1.05, at least 1.1, at least 1.2, at least 1.5, at least 2, at least 5, at least 10, at least 50, at least 100, at least 1,000, at least 10,000, at least 100,000, at least 1,000,000, at least 10,000,000, and/or up to 100,000,000, up to 1,000,000,000, or more. Combinations of these ranges (e.g., greater than or equal to 1.005 and less than or equal to 1,000,000,000, greater than or equal to 2 and less than or equal to 1,000,000) are possible. In some embodiments, the release stream is free of bicarbonate anions. In some embodiments, the molar ratio of the concentration of carbonate anions in the second capture stream to the concentration of carbonate anions in the release stream is at least 1.005, at least 1.01, at least 1.05, at least 1.1, at least 1.2, at least 1.5, at least 2, at least 5, at least 10, at least 50, at least 100, at least 1,000, at least 10,000, at least 100,000, at least 1,000,000, at least 10,000,000, and/or up to 100,000,000, up to 1,000,000,000, or more. Combinations of these ranges (e.g., greater than or equal to 1.005 and less than or equal to 1,000,000,000, greater than or equal to 2 and less than or equal to 1,000,000) are possible. In some embodiments, the release stream is free of carbonate anions.

In some embodiments, one or more streams produced in the system are recycled to another component of the system. For example, in some embodiments, the aqueous input stream comprises at least a portion (e.g., at least 0.5 wt %, at least 1 wt %, at least 2 wt %, at least 5 wt %, at least 10 wt %, at least 25 wt %, at least 50 wt %, at least 75 wt %, at least 90 wt %, at least 95 wt %, at least 98 wt %, at least 99 wt %, at least 99.9 wt %, or all) of the release stream. As shown in FIG. 3B, for example, aqueous input stream 116 may comprise at least a portion of release stream 117. In some embodiments, the aqueous input stream comprises at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the solute (e.g., dissolved cations such as dissolved metal cations and/or ammonium cations and dissolved anions such as dissolved non-hydroxide anions) of the release stream. In some embodiments, the aqueous input stream comprises at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the water of the release stream. It has been realized in the context of this disclosure that the methods of this disclosure (e.g., involving recycling of the release stream comprising the dissolved cations and non-hydroxide anions) can result in advantages, including but not limited to reducing costs (less or no consumption of reagents), operating without liquid discharge or low liquid discharge (and without discharge of any portion of the streams to the environment), not needing to co-locate the facility with a source of brine/salt, and/or achieving improved thermal efficiency due, in some embodiments, to the recycle stream being maintained at near-reactor temperature compared to the need to heat new reagents that are added to the process.

In some embodiments, one or more electrochemical assembly liquid inlets are fluidically connected (directly or indirectly) to the second contact vessel liquid outlet of the second gas-liquid contact vessel. Such a fluidic connection may facilitate the recirculating of at least a portion of the release stream to the electrochemical assembly via the aqueous input stream. For example, FIG. 3B shows electrochemical assembly liquid inlet 119 as being fluidically connected to second gas-liquid contact vessel liquid outlet 136 (with the fluidic connection in FIG. 3B being an indirect fluidic connection due to the intervening combination of proton-rich product solution 104 and second capture stream 111 forming release stream 117).

In some embodiments, the aqueous input stream is a first aqueous input stream, and the method further comprises transporting a second aqueous input stream to the electrochemical cell, wherein the second aqueous input stream comprises at least a portion (e.g., at least 0.5 wt %, at least 1 wt %, at least 2 wt %, at least 5 wt %, at least 10 wt %, at least 25 wt %, at least 50 wt %, at least 75 wt %, at least 90 wt %, at least 95 wt %, at least 98 wt %, at least 99 wt %, at least 99.9 wt %, or all) of the base-rich product solution.

In some embodiments, more than two different sources of carbon dioxide for supplying the various input gas streams are employed. For example, in some embodiments, a third input gas stream comprising carbon dioxide is employed, at least a portion of which is from a third source that is different than the first source and different from the second source. For example, in some embodiments where the first source is ambient air and the second source is a first point source of carbon dioxide, the third source is a different point source (e.g., a different industrial effluent). In some embodiments, different input gas streams from at least three different sources, at least four different sources, at least five different sources, at least 10 different sources, and/or up to twenty different sources, or more are employed for capturing carbon dioxide. In some embodiments in which the more than two different sources of carbon dioxide supplying the various input gas stream are employed, the sources may be arranged in series and/or parallel.

In some embodiments, carbon dioxide from a third input gas stream from a third source is captured. For example, in some embodiments, at least some (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up 99 mol %, or all) of the second capture stream is exposed to carbon dioxide from the third input gas stream. This exposure of at least a portion of the second capture stream to the carbon dioxide from the third input gas stream may result in the generation of a third carbon dioxide-lean output gas stream and a third capture stream, as discussed below. As an example, in FIG. 1B, at least a portion of second capture stream 111 exiting second contact vessel liquid outlet 136 is transported to third contact vessel liquid inlet 146 of third gas-liquid contact vessel 137, while third input gas stream 112 is transported to third contact vessel gas inlet 147 of third gas-liquid contact vessel 137, such that each is input into third gas-liquid contact vessel 137. In third gas-liquid contact vessel 137, the presence of basic species such as bicarbonate anions, carbonate anions, and/or hydroxide ions induces, via one or more acid-base equilibrium reactions, the removal of carbon dioxide from third input gas stream 112 to form third carbon dioxide-lean output gas stream 113 exiting third contact vessel gas outlet 138 and third capture stream 114. Third capture stream 114 may then participate in a similar protic-species induced release of carbon dioxide as discussed earlier in the context of the second capture stream, as shown in FIG. 3C. The capture process in the third contact vessel may involve the same or similar acid-base equilibrium reactions involving carbon dioxide, bicarbonate, carbonates, and/or hydroxide ions discussed above in the contact of the capture from the first input gas stream and/or the second input gas stream.

Any of a variety of gas streams from any of a variety of sources may be employed as the third input gas stream. In some embodiments, at least a portion (e.g., at least 50 mol %, at least 75 mol %, at least 90 mol %, and/or up to 95 mol %, up to 98 mol %, up 99 mol %, or all) of the third input gas stream is from the third source. In some embodiments, the third input gas stream is, comprises, or is derived from industrial effluent. For example, the third input gas stream may comprise or be derived from flue gas. As noted above, the third source, which supplies at least a portion of the third input gas stream, may be different than the first source that supplies the first input gas stream and the second source that supplies the second input gas stream. In some embodiments, the third source is a point source of carbon dioxide (examples of which are provided above in the context of the second source).

In some embodiments, the third input gas stream is free of gas from the first source and gas from the second source or comprises gas from the first source or the second source in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. In some embodiments, the third input gas stream is free of carbon dioxide from the first source and carbon dioxide from the second source or comprises carbon dioxide from the first source or the second source in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. In some embodiments, the third input gas stream is free of ambient air or comprises ambient air in an amount of less than or equal to 10 mol %, less than or equal to 5 mol %, less than or equal to 2 mol %, less than or equal to 1 mol %, less than or equal to 0.5 mol %, less than or equal to 0.2 mol %, less than or equal to 0.1 mol %, less than or equal to 0.01 mol %, or less. However, in some embodiments, the second input gas stream comprises ambient air and/or a component from ambient air such as nitrogen gas. In some embodiments, the first source is ambient air, the second source is a first point source, and the third source is a second, different point source of carbon dioxide.

While the third input gas stream may be referred to as a stream, this is not to imply any particular flow rate or type of flow path for the stream.

In some embodiments, the third input gas stream comprises carbon dioxide at a higher concentration than the first input gas stream and the second input gas stream. In some embodiments, the third input gas stream comprises carbon dioxide at a higher partial pressure than the partial pressure of carbon dioxide in the first input gas stream and the partial pressure of carbon dioxide in the second input gas stream.

As noted above, the interaction between the carbon dioxide from the third input gas stream and the bicarbonate (and in some instances carbonate anions) from the second capture stream (e.g., via one or more acid-base equilibrium reactions) may produce a third carbon dioxide-lean output gas stream. For example, in FIG. 1B, third carbon dioxide-lean output gas stream 113 may be output from third contact vessel gas outlet 138 of third gas-liquid contact vessel 137. The third carbon dioxide-lean output gas stream may have a lower concentration of carbon dioxide than the third input gas stream. The third carbon dioxide-lean output gas stream may have a lower number of moles of carbon dioxide than the third input gas stream. In some embodiments, a relatively high percentage of carbon dioxide in the third input gas stream is removed in forming the third carbon dioxide-lean output gas stream.

In some embodiments, the interaction between the carbon dioxide from the third input gas stream and the carbonate anions from the first capture stream (e.g., via one or more acid-base equilibrium reactions) and/or bicarbonate anions from the second capture stream produces a third capture stream. For example, in FIG. 1B, third capture stream 114 may be output from third contact vessel liquid outlet 139 of third gas-liquid contact vessel 137. The third capture stream may comprise captured carbon dioxide in the form of, for example, dissolved bicarbonate anions, at least some of which are formed from carbon dioxide from the third input gas stream (e.g., upon exposure of carbonate anions from the first capture stream to carbon dioxide from the third input gas stream).

In some embodiments, the third capture stream comprises dissolved bicarbonate anions. At least some (e.g., at least 1 mol %, at least 2 mol %, at least 5 mol %, at least 10 mol %, at least 25 mol %, at least 40 mol %, at least 50 mol %, at least 75 mol %, at least 90 mol %, at least 95 mol %, at least 98 mol %, at least 99 mol %, at least 99.9 mol %, or all) of the bicarbonate anions in the third capture stream are generated from carbonate anions from the second capture stream by the reaction resulting from exposure of the at least a portion of the second capture stream to carbon dioxide from the third input gas stream (e.g., as discussed above).

The third capture stream may have a relatively high concentration of dissolved bicarbonate anions. For example, in some embodiments, the third capture stream comprises dissolved bicarbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible.

In some embodiments, the concentration of bicarbonate anions in the third capture stream is greater than a concentration of bicarbonate anions in the first capture stream. In some, but not necessarily all embodiments, the first capture stream is free of bicarbonate anions while the third capture stream comprises bicarbonate anions. In some embodiments in which the first capture stream comprises bicarbonate anions, the molar ratio of the concentration of bicarbonate anions in the third capture stream to the concentration of bicarbonate anions in the first capture stream is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments in which carbonate anions and bicarbonate anions are both present in both the first capture stream and the third capture stream, the ratio of bicarbonate anions to carbonate anions in the third capture stream is greater than the ratio of bicarbonate anions to carbonate anions in the first capture stream. This change in ratio may be due to some or all of the carbonate anions from the first capture stream being converted to bicarbonate anions in the third capture stream due to the reaction induced by the presence of additional carbon dioxide from the third input gas stream. In some embodiments, the molar ratio of the concentration of bicarbonate anions in the third capture stream to the concentration of carbonate anions in the third capture stream is greater than the molar ratio of the concentration of bicarbonate anions in the first capture stream to the concentration of carbonate anions in the first capture stream (e.g., by a factor of at least 1.01, at least 1.02, at least 1.05, at least 1.1, at least 1.2, at least, 1.5, at least 2, at least 5, at least 10, at least 20, and/or up to 50, up to 100, or more).

In some, but not necessarily all embodiments, the third capture stream may have a relatively high concentration of dissolved carbonate anions. For example, in some embodiments, the third capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible.

In some embodiments, third capture stream has a relatively high pH. For example, in some embodiments, the third capture stream has a pH of greater than or equal to 5, greater than or equal to 6, greater than or equal to 7, greater than or equal to 8, greater than or equal to 9, greater than or equal to 10, greater than or equal to 11, greater than or equal to 12, and/or up to 13, up to 14, or greater. Combinations of these ranges are possible. In some embodiments, the third capture stream has a lower pH than the first captures stream (e.g., by at least 0.05 pH units, by at least 1 pH, by at least 2 pH units, by at least 3 pH units, or more).

In some embodiments, the third capture stream comprises at least some of the dissolved cations (e.g., the metal cations and/or ammonium cations discussed above). The cations may be from the base-rich product solution. For example, the cations in the third capture stream may constitute at least a portion (e.g., at least 0.5 mol %, at least 1 mol %, at least 2 mol %, at least 5 mol %, at least 10 mol %, at least 25 mol %, at least 50 mol %, at least 75 mol %, at least 90 mol %, and/or up to 95 mol %, up to 98 mol %, up to 99 mol %, or all) of the cations in the base-rich product solution. In some embodiments, the cations may also be from the first capture stream. For example, a first capture stream comprising dissolved M₂CO₃ may be transported to the third gas-liquid contact vessel, and a third capture stream comprising dissolved MHCO₃ (e.g., NaHCO₃) may be produced by the third gas-liquid contact vessel upon interaction (e.g., contacting and/or mixing) with the third input gas stream.

In some embodiments, the third capture stream is discharged from the system.

However, in other embodiments, the third capture stream is transported to a different component of the system for further treatment (e.g., exposure to acidic species to promote release of gaseous carbon dioxide).

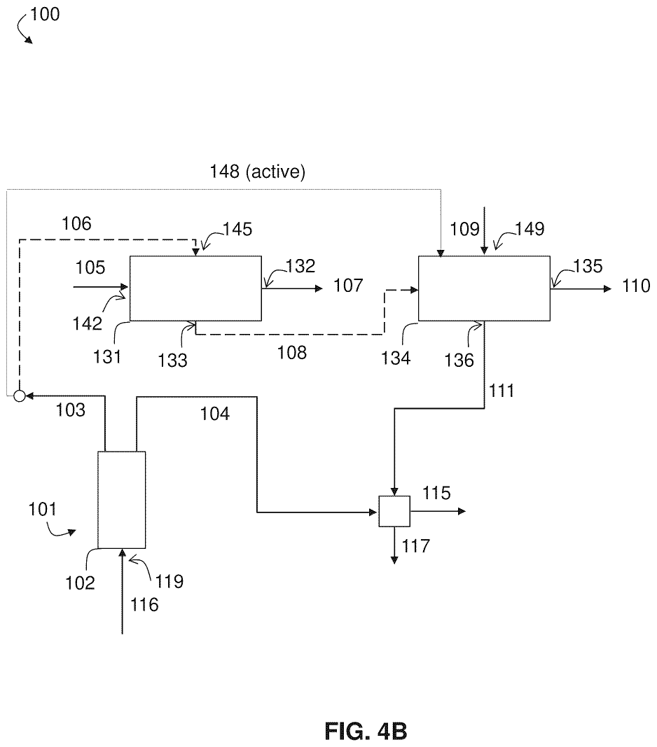

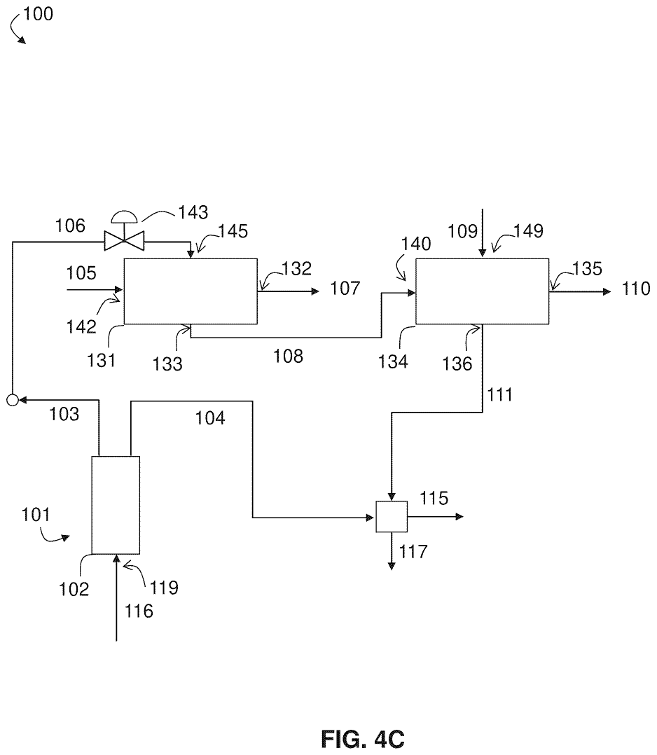

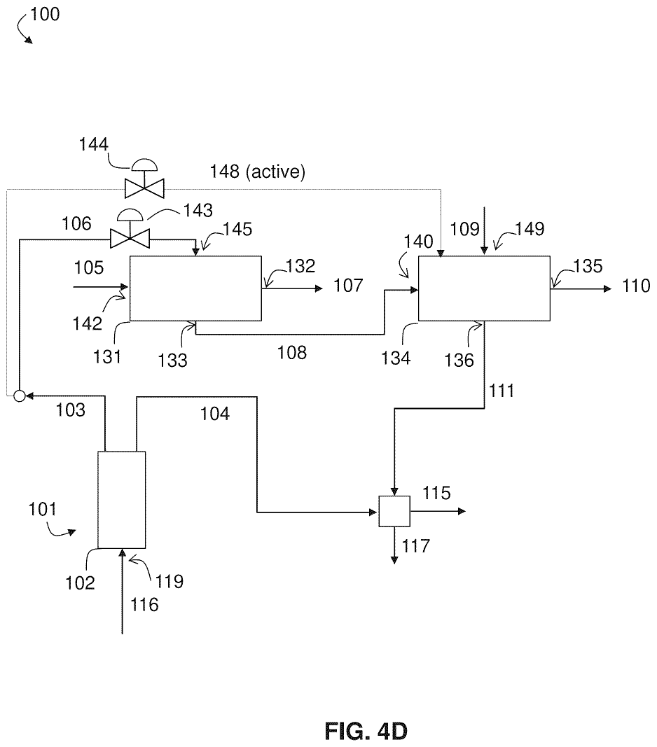

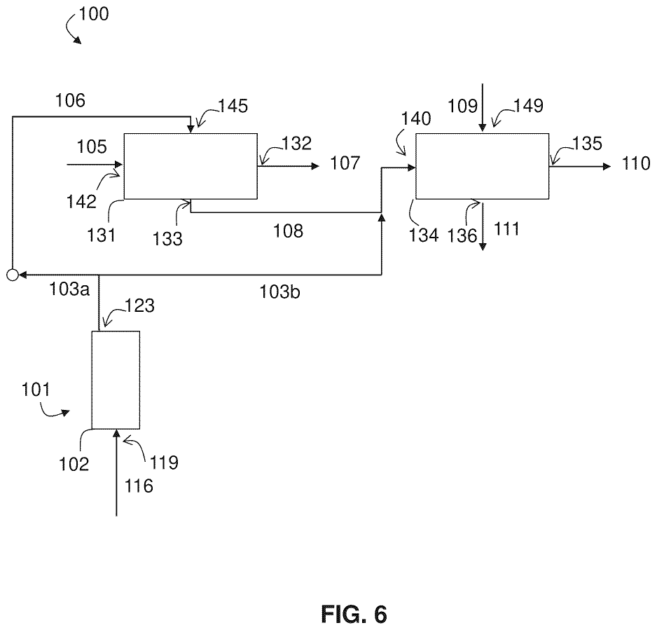

In some embodiments, the configuration of the system and/or operational parameters of the process are time-dependent. Such a time dependency may permit tailoring of the system's operation to external conditions, such as the availability of electricity and/or the availability of, for example, carbon dioxide from the second source. For example, this process may vary the relative fraction or total amount of DAC and point source capture in order to tailor capture to process economics. For example, variations in time of day or time of the year may result in different electrical grid conditions and prices which favor decarbonization via DAC or via point source capture. This process of this disclosure may be flexible and could in such instances simply route capture caustic solution to either the first gas-liquid contact vessel (e.g., an air contactor) or the second gas-liquid contact vessel (e.g., the flue gas scrubber) as needed. In some embodiments, the process of this disclosure can route capture caustic solution to both the first gas-liquid contact vessel (e.g., an air contactor) and the second gas-liquid contact vessel (e.g., the flue gas scrubber), either simultaneously or sequentially. In some embodiments, the system is capable of transporting base-rich product solution to the first gas-liquid contact vessel and the second gas-liquid contact vessel simultaneously. Accordingly, in some embodiments, the electrochemical assembly liquid outlet and the second contact vessel liquid inlet are fluidically connected. For example, in the embodiment shown in FIG. 6, first liquid outlet 123 (serving as the electrochemical assembly liquid outlet) produces first portion 103a of base-rich product solution routed to first gas-liquid contact vessel 131, while first liquid outlet 123 is also fluidically connected to second contact vessel liquid inlet 140 such that second portion 103b of base-rich product solution is routed (e.g., directly) to second gas-liquid contact vessel 134. In some embodiments, a first portion electrogenerated basic species is exposed to carbon dioxide from the first input gas stream. In some such embodiments, a second portion electrogenerated basic species is exposed to carbon dioxide from the first input gas stream (e.g., simultaneously or sequentially). In some embodiments, the exposure of at least some of the electrogenerated basic species to carbon dioxide from the first input gas stream and the exposure of at least a portion of the first capture stream to carbon dioxide from the second input gas stream are performed during a first period of time. In some such embodiments, the method further comprises, during a second period of time after the first period time, exposing at least some of the electrogenerated basic species to carbon dioxide from the second input gas stream, without first exposing the at least some of the electrogenerated basic species to carbon dioxide from the first input gas stream, to generate the second capture stream comprising dissolved bicarbonate anions formed from the carbon dioxide from the second input gas stream. The time-dependency may involve use of a bypass stream. The bypass stream may be configured such that some or all of the electrogenerated basic species from the base-rich product solution bypass exposure to the first input gas stream (e.g., in the first gas-liquid contact vessel). For example, FIGS. 4A-4B and 4D show system 100 comprising bypass stream 148, with system 100 configured such that at least a portion of base-rich product solution 103 is transported to first gas-liquid contact vessel 131 under a first configuration during a first period of time (FIG. 4A, as shown with the solid line and bypass stream as a dashed line), and at least a portion of base-rich product solution 103 is transported to second gas-liquid contact vessel 134 via bypass stream 148 without first going to first gas-liquid contact vessel 131 under a second configuration during a second period of time (FIG. 4B, as shown with bypass stream 148 as a solid line and stream 106 as a dashed line).

In some embodiments, the time-dependency involves altering a rate of generation of carbonate anions from the exposure of the electrogenerated basic species to carbon dioxide from the first input gas stream. For example, the rate may be lower during the second period of time. This may permit a greater extent of capturing occurring from exposure of electrogenerated basic species to the second input gas stream as compared to the first input gas stream as relative to during the first period of time. In some embodiments, the exposure of at least some of the electrogenerated basic species to carbon dioxide from the first input gas stream and the exposure of at least a portion of the first capture stream to carbon dioxide from the second input gas stream are performed during a first period of time and a second period of time (the second period of time being after the first period of time). In some such embodiments, the method comprises adjusting one or more operational parameters such that a first rate of generation of carbonate anion in the first capture stream during the first period of time is different than a second rate of generation of carbonate anions in the first capture stream during the second period of time. In some embodiments, the first rate is greater than the second rate. In some embodiments, the adjusting the one or more operational parameters comprises changing a time of exposure between the carbon dioxide from the first input gas stream and the at least a portion of the electrogenerated basic species. In some embodiments, the changing the time of exposure comprises changing a volume available for mass transfer (such as reducing the number of contacting units in some embodiments where the first contact vessel comprises a multiplicity of contacting units (e.g., sub-vessels), e.g., arranged fluidically in parallel) between the first input gas stream and/or a stream comprising the electrogenerated basic species contacting the carbon dioxide from the first input gas stream. In some embodiments, the changing the time of exposure comprises change a flow rate of the first input gas stream and/or a stream comprising the electrogenerated basic species contacting the carbon dioxide from the first input gas stream. For example, product solution control valving 143 in FIGS. 4C-4D and/or bypass stream control valve 144 in FIG. 4D may be employed to control a flow rate of first gas-liquid contact vessel inlet stream 106 into first gas-liquid contact vessel 131. In some embodiments, the adjusting the one or more operational parameters comprises adjusting a surface area of liquid comprising the electrogenerated basic species available to contact the carbon dioxide from the first input gas stream.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two components connected by a valve and conduits that permit flow between the components in at least one configuration of the valve would be said to be fluidically connected to each other. To further illustrate, two components that are connected by a valve and conduits that permit flow between the components in a first valve configuration but not a second valve configuration are considered to be fluidically connected to each other both when the valve is in the first configuration and when the valve is in the second configuration. In contrast, two components that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

### Example Embodiment

An example embodiment is now described. This implementation of a combined DAC-point source capture system may improve the overall hydroxide efficiency. Due to the higher CO₂ concentration in point source emissions (from fossil fuel power plants, steel, cement, aluminum, or other industrial processes), Reaction 3 is driven by both kinetics and thermodynamics towards completion. Importantly, the systems and methods of this example embodiment employ an electrochemical caustic regeneration system which allows flexible tandem DAC+point source capture because CO₂ release can be performed identically by addition of acid equivalents produced in the electrochemical cell.

In an example carbon capture electrochemical cell, a cathode can drive the production of caustic (as examples, NaOH, KOH, & LiOH) by performing various reduction reactions (hydrogen evolution, oxygen reduction, CO₂ reduction) and an anode can drive the production of acid (as examples, HCl, H₂SO₄, H₃PO₄, HNO₃ and their conjugate acids/bases) by performing various oxidation reactions (hydrogen oxidation, oxygen evolution). Examples of the stoichiometries of these reactions for the H₂ cathode/anode reaction couple are shown below in Reactions 5 and 6.

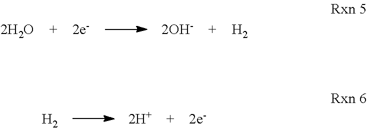

As can be seen above, the quantity of hydroxide ions and protons are stoichiometrically matched when using electrochemical caustic generation systems. After the caustic is produced in Reaction 5, a DAC process can be employed using a spray tower, cooling tower, packed scrubber, or other gas-liquid contacting systems. This produces a predominantly carbonate stream as described by Reactions 1 and 2.

Then, this predominantly carbonate stream can be used as the capture solution for a point-source emission which will be driven further to bicarbonate due to the higher concentration of CO₂ in the feed via Reaction 3. This capture could be performed in a spray tower, packed bed scrubber, bubble column, or other methods of liquid gas contacting. With full conversion, this would reach a hydroxide efficiency of 1 as defined in Reaction 4.

Next, this capture solution is contacted with the acid generated in Reaction 6 as depicted in Reaction 7:

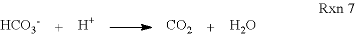

The process has now produced purified, captured CO₂ and is ready for another cycle of caustic/acid generation via the electrochemical cell.

Thus, the combined DAC+point source electrochemical process may improve the hydroxide efficiency of carbon capture, greatly improving economic viability.

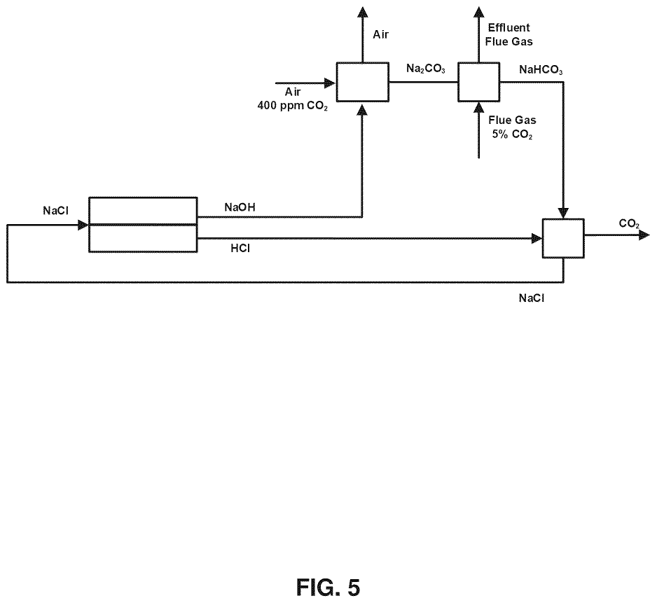

FIG. 5 shows a schematic diagram of this example embodiment process, in which sodium chloride salt, NaCl, can be used for production of caustic, e.g., NaOH, and acid e.g., HCl, using an electrochemical reactor. This reactor can be operated using hydrogen evolution and oxidation (Reactions 5, and 6). The produced caustic solution can then be fed to an air contactor which scrubs CO₂ at the 400 ppm level and produces a stream rich in sodium carbonate, Na₂CO₃. Then, this solution is used to capture CO₂ from a point source emission stream, containing 4% CO₂ by volume as is typical of natural gas electrical power plants. This capture could occur in a typical packed bed scrubber. Capture of CO₂ from this stream results in a stream enriched in sodium bicarbonate, NaHCO₃, which is then contacted with the electrochemically generated HCl which releases the CO₂ and produces salt ready for recycling to the process.

At a typical cell voltage of 1.5 V, the energy required to produce NaOH with this cell corresponds to ˜1 MWh/ton. By implementing the tandem DAC+Point Source scheme the hydroxide efficiency (Reaction 4) may be improved from 2 to 1. This hydroxide efficiency is corresponds to an energy of 0.9 MWh/ton_{CO2} which is much lower than the value of 1.8 MWh/ton_{CO2} which comes from the simple DAC case with a hydroxide efficiency of 2. Another illustrative example embodiments is now described. An aqueous input stream comprising a salt solution comprising dissolved K⁺ cations is fed to the anode chamber of an electrochemical cell and a catholyte solution containing dissolved KOH at a concentration of 10 wt. % is fed to the catholyte chamber. The anolyte chamber and the catholyte chambers are separated by a cation exchange membrane (e.g., Nafion 2050). A voltage of 0.9V is applied between the cathode and anode, causing additional hydroxide ions to be formed at the cathode, which are charge-balanced by K⁺ cations migrating across the cation exchange membrane, thereby resulting in a base-rich product solution containing dissolved KOH at a concentration of 12 wt. %.

This base-rich product solution is fed to the first contact vessel, where it is contacted with a first input gas stream in the form of an ambient air stream of approximately 40% relative humidity containing carbon dioxide at a concentration of approximately 420 ppm (mole basis). Within the contact vessel a vast majority but not all of the carbon dioxide from the ambient air reacts with the hydroxide ions in the liquid solution to produce carbonate ions. The gas stream leaving the first contactor is depleted in carbon dioxide. The first capture stream leaves the first contact vessel as a liquid solution having a composition comprising dissolved K₂CO₃ and KOH (at a smaller but still significant concentration), and a trace amount of KHCO₃.

The first capture stream is fed to the second contact vessel, an absorption column containing structured packing (MellaCarbon™), where it contacts a second input gas stream which contains flue gas from a natural gas combined cycle (NGCC) power plant. The second input gas stream has a concentration orders of magnitude greater than ambient air, and nearly all of the inlet CO₂ is removed. The second capture stream leaves the second contact vessel as a liquid solution having a composition having a significant concentration of dissolved K₂CO₃ but also a several times higher concentration of dissolved KHCO₃, along with trace amount of KOH.

Based on the outlet composition of the second capture stream, it is believed that the basic species carbon efficiency number (E_{B}) would be indicative of advantageous efficiency U.S. Provisional Patent Application No. 63/711,680, filed Oct. 24, 2024, and entitled “Carbon Dioxide Capture Using Different Gas Input Streams,” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” 0 or “exactly one of.” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of.” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first.” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising.” “including,” “carrying.” “having.” “containing.” “involving.” “holding.” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for at least partially separating carbon dioxide from a gas stream, comprising:
transporting an aqueous input stream to an electrochemical cell;
applying an electrical potential difference across the electrochemical cell and performing one or more reactions involving at least one component of the aqueous input stream to produce a base-rich product solution comprising electrogenerated basic species;
exposing at least some of the electrogenerated basic species to carbon dioxide from a first input gas stream, at least a portion of the first input gas stream being from a first source, to generate:
a first carbon dioxide-lean output gas stream having a lower concentration of carbon dioxide than the first input gas stream; and
a first capture stream comprising dissolved carbonate anions formed from the carbon dioxide from the first input gas stream; and
exposing at least a portion of the first capture stream to carbon dioxide from a second input gas stream, at least a portion of the second input gas stream being from a second, different source, the second input gas stream comprising carbon dioxide at a higher concentration and/or partial pressure than the first input gas stream to generate:
a second carbon dioxide-lean output gas stream having a lower concentration of carbon dioxide than the second input gas stream; and
a second capture stream comprising dissolved bicarbonate anions, at least some of which are generated from carbonate anions from the first capture stream by a reaction resulting from exposure of the at least a portion of the first capture stream to carbon dioxide from the second input gas stream.

2. The method of claim 1, wherein the basic species comprise hydroxide anions.

3. The method of claim 1, wherein the first capture stream comprises bicarbonate anions formed from the carbon dioxide from the first input gas stream.

4. The method of claim 1, wherein a concentration of bicarbonate anions in the second capture stream is greater than a concentration of bicarbonate anions in the first capture stream.

5. The method of claim 1, wherein a molar ratio of a concentration of bicarbonate anions in the second capture stream to a concentration of carbonate anions in the second capture stream is greater than a molar ratio of a concentration of bicarbonate anions in the first capture stream to a concentration of carbonate anions in the first capture stream.

6. The method of claim 1, wherein the method is performed with a basic species carbon efficiency number (E_{B}) that is less than or equal to 1.9, wherein E_{B} is defined as:
$${E}_{B} = 1 + \frac{{[ {CO}_{3}^{2 -} ]}_{s e c o n d}}{{[ {CO}_{3}^{2 -} ]}_{s e c o n d} + {[ {HCO}_{3}^{-} ]}_{s e c o n d}}$$
wherein
$${[ {CO}_{3}^{2 -} ]}_{s e c o n d}$$
is a molar concentration of carbonate anions in the second capture stream, and wherein
$${[ {HCO}_{3}^{-} ]}_{s e c o n d}$$
is a molar concentration of bicarbonate anions in the second capture stream.

7. The method of claim 1, wherein the exposing the at least some of the electrogenerated basic species to the carbon dioxide comprises contacting at least a portion of the base-rich product solution with the first input gas stream in a first gas-liquid contact vessel.

8. The method of claim 1, wherein the exposing the at least some of the first capture stream to the carbon dioxide from the second input gas stream is performed in a second gas-liquid contact vessel.

9. The method of claim 11, wherein at least some of the bicarbonate anions in the second capture stream are generated due the presence of residual basic species from the first capture stream during the exposure of the at least some of the first capture stream to carbon dioxide from the second input gas stream.

10. The method of claim 1, wherein the one or more reactions further produce a proton-rich product solution comprising an electrogenerated protic species.

11. The method of claim 10, wherein the proton-rich product solution has a lower pH than the aqueous input stream.

12. The method of claim 10, wherein the electrogenerated protic species comprise electrogenerated acidic species.

13. The method of claim 12, wherein the acidic species comprise hydronium ions.

14. The method of claim 10, wherein the protic species comprises acetic acid.

15. The method of claim 10, wherein the protic species comprises benzoic acid.

16. The method of claim 10, wherein the protic species comprises formic acid.

17. The method of claim 10, wherein the protic species comprises phosphoric acid (H₃PO₄).

18. The method of claim 10, wherein the protic species comprises dihydrogen phosphate ions (H₂PO₄⁻).

19. The method of claim 10, wherein the protic species comprises boric acid (H₃BO₃).

20. The method of claim 10, further comprising exposing at least some of the electrogenerated protic species to at least some of the dissolved bicarbonate anions from the second capture stream to generate a carbon dioxide-rich output gas stream having a higher concentration of carbon dioxide than the first input gas stream.

21. The method of claim 10, further comprising exposing at least some of the electrogenerated protic species to at least some of the dissolved bicarbonate anions from the second capture stream to generate a carbon dioxide-rich output gas stream having a higher concentration of carbon dioxide than the second input gas stream.

22. The method of claim 20, wherein the exposing at least some of the electrogenerated protic species to at least some of the dissolved bicarbonate anions from the second capture stream further generates a release stream comprising bicarbonate anions at a concentration that is less than the concentration of bicarbonate anions in the second capture stream.

23. The method of claim 22, wherein the aqueous input stream comprises at least a portion of the release stream.

24. The method of claim 1, wherein the aqueous input stream is a first aqueous input stream, and the method further comprises transporting a second aqueous input stream to the electrochemical cell, wherein the second aqueous input stream comprises at least a portion of the base-rich product solution.

25. The method of claim 1, wherein the first input gas stream comprises carbon dioxide at a concentration of greater than or equal to 250 ppm on a molar basis and less than or equal to 100,000 ppm on a molar basis.

26. The method of claim 1, wherein the first input gas stream comprises carbon dioxide at a concentration of greater than or equal to 250 ppm on a molar basis and less than or equal to 1,000 ppm on a molar basis.

27. The method of claim 1, wherein the first input gas stream is ambient air.

28. The method of claim 1, wherein the second input gas stream comprises carbon dioxide at a concentration of greater than or equal to 0.2 mol % and less than or equal to 50 mol %.

29. The method of claim 1, wherein the second input gas stream comprises carbon dioxide at a higher partial pressure than a partial pressure of carbon dioxide in the first input gas stream.

30. The method of claim 1, wherein the second input gas stream comprises carbon dioxide at a higher partial pressure than a partial pressure of carbon dioxide in the first input gas stream by greater than or equal to 0.001 bar.

31. The method of claim 1, wherein the second input gas stream comprises carbon dioxide at a partial pressure of greater than or equal to 0.002 bar and less than or equal to 40 bar.

32. The method of claim 1, wherein the second source is a point source of carbon dioxide.

33. The method of claim 32, wherein the point source comprises a power plant, a cement production facility, a steel production facility, an aluminum production facility, a steam methane reforming facility, an autothermal reforming facility, a natural gas wellhead, a natural gas pipeline, a paper mill, and/or a Haber-Bosch facility.

34. The method of claim 1, wherein the second input gas stream comprises flue gas.

35. The method of claim 1, wherein the aqueous input stream comprises dissolved cations and dissolved anions, wherein the dissolved cations comprise metal cations and/or ammonium cations, and wherein the dissolved anions comprise non-hydroxide anions.

36. The method of claim 35, wherein the dissolved cations comprise alkali metal cations and/or ammonium cations.

37. The method of claim 35, wherein the dissolved anions comprise halide ions, oxyanions, and/or conjugate bases of organic acids.

38. The method of claim 35, wherein the dissolved anions comprise halide ions, sulfate ions, nitrate ions, phosphate ions, borate ions, and/or conjugate bases of organic acids.

39. The method of claim 35, wherein the dissolved anions comprise conjugate bases of weak acids.

40. The method of claim 35, wherein the dissolved anions comprise chloride ions.

41. The method of claim 35, wherein the dissolved anions comprise phosphate ions.

42. The method of claim 41, wherein the phosphate ions comprise orthophosphate ions (PO₄³⁻), monohydrogen phosphate ions (HPO₄²⁻), and/or dihydrogen phosphate ions (H₂PO₄⁻).

43. The method of claim 35, wherein the base-rich product solution comprises at least some of the dissolved cations.

44. The method of claim 35, wherein the first capture stream and the second capture stream each comprises at least some of the dissolved cations.

45. The method of claim 35, wherein the one or more reactions further produce a proton-rich product solution comprising an electrogenerated protic species, wherein the proton-rich product solution comprises at least some of the dissolved anions.

46. The method of claim 22, wherein the aqueous input stream comprises dissolved cations and dissolved anions, wherein the dissolved cations comprise metal cations and/or ammonium cations, wherein the dissolved anions comprise non-hydroxide anions, and wherein the release stream comprises at least some of the dissolved anions.

47. The method of claim 1, wherein the electrochemical cell is an electrolytic cell.

48. The method of claim 1, wherein the electrochemical cell comprises a catholyte chamber and an anolyte chamber separated by at least one ion-selective membrane.

49. The method of claim 48, wherein the at least one ion-selective membrane comprises a cation-selective membrane, and wherein the aqueous input stream is transported to the anolyte chamber.

50. The method of claim 48, wherein the at least one ion-selective membrane comprises an anion-selective membrane, and wherein the aqueous input stream is transported to the catholyte chamber.

51. The method of claim 48, wherein the electrochemical cell further comprises an electrolyte chamber separated from the catholyte chamber by a cation-selective membrane and separated from the anolyte chamber by an anion-selective membrane, and wherein the aqueous input stream is transported to the electrolyte chamber.

52. The method of claim 48, wherein the performing the one or more reactions comprises performing the hydrogen oxidation reaction in the anolyte chamber and performing the hydrogen evolution reaction in the catholyte chamber.

53. The method of claim 48, wherein the performing the one or more reactions comprises performing the hydrogen oxidation reaction in the anolyte chamber and performing the oxygen reduction reaction in the catholyte chamber.

54. The method of claim 48, wherein the performing the one or more reactions comprises performing the oxygen evolution reaction in the anolyte chamber and performing the oxygen reduction reaction in the catholyte chamber.

55. The method of claim 1, wherein the electrochemical cell is operated as an electrodialysis cell.

56. The method of claim 1, wherein the electrochemical cell comprises a bipolar membrane.

57. The method of claim 1, further comprising exposing at least a portion of the second capture stream to carbon dioxide from a third input gas stream from a third source comprising carbon dioxide at a higher concentration than the first input gas stream and at a different concentration than the second input gas stream to generate:
a third carbon dioxide-lean output gas stream having a lower concentration of carbon dioxide than the third input gas stream; and
a third capture stream comprising dissolved bicarbonate anions, at least some of which are generated from carbonate anions from the second capture stream by a reaction resulting from exposure of the at least a portion of the second capture stream to carbon dioxide from the third input gas stream.

58. The method of claim 1, wherein:
the exposing at least some of the electrogenerated basic species to carbon dioxide from the first input gas stream and the exposing at least a portion of the first capture stream to carbon dioxide from the second input gas stream are performed during a first period of time, and
the method further comprises, during a second period of time after the first period time, exposing at least some of the electrogenerated basic species to carbon dioxide from the second input gas stream, without first exposing the at least some of the electrogenerated basic species to carbon dioxide from the first input gas stream, to generate the second capture stream comprising dissolved bicarbonate anions formed from the carbon dioxide from the second input gas stream.

59. The method of claim 1, wherein the exposing at least some of the electrogenerated basic species to carbon dioxide from the first input gas stream and the exposing at least a portion of the first capture stream to carbon dioxide from the second input gas stream are performed during a first period of time and a second period of time, and wherein the method comprises adjusting one or more operational parameters such that a first rate of generation of carbonate anion in the first capture stream during the first period of time is different than a second rate of generation of carbonate anions in the first capture stream during the second period of time.

60. The method of claim 59, wherein the first rate is greater than the second rate.

61. The method of claim 59, wherein the adjusting the one or more operational parameters comprises changing a time of exposure between the carbon dioxide from the first input gas stream and the at least a portion of the electrogenerated basic species.

62. The method of claim 61, wherein the changing the time of exposure comprises change a flow rate of the first input gas stream and/or a stream comprising the electrogenerated basic species contacting the carbon dioxide from the first input gas stream.

63. The method of claim 59, wherein the adjusting the one or more operational parameters comprises adjusting a surface area of liquid comprising the electrogenerated basic species available to contact the carbon dioxide from the first input gas stream.

64. The method of claim 1, wherein the second input gas stream comprises carbon dioxide at a higher concentration than a concentration of carbon dioxide in the first input gas stream.

65. The method of claim 1, wherein the second input gas stream comprises carbon dioxide at a higher partial pressure than a partial pressure of carbon dioxide in the first input gas stream.

66. The method of claim 1, wherein a first portion electrogenerated basic species are exposed to carbon dioxide from the first input gas stream, and a second portion electrogenerated basic species are exposed to carbon dioxide from the first input gas.

67. (canceled)

68. An industrial-scale system for at least partially separating carbon dioxide from a gas stream, comprising:
an electrochemical assembly comprising:
an electrochemical cell;
an electrochemical assembly liquid inlet configured to receive an aqueous input stream; and
an electrochemical assembly liquid outlet configured to output a solution comprising a product species generated at least in part by one or more reactions performed in the electrochemical assembly;
a first gas-liquid contact vessel comprising:
a first contact vessel gas inlet configured to receive a first input gas stream comprising carbon dioxide from a first source;
a first contact vessel liquid inlet fluidically connected to the electrochemical assembly liquid outlet;
a first contact vessel gas outlet; and
a first contact vessel liquid outlet; and
a second gas-liquid contact vessel comprising:
a second contact vessel gas inlet configured to receive a second input gas stream comprising carbon dioxide from a second source that is different than the first source;
a second contact vessel liquid inlet fluidically connected to the first contact vessel liquid outlet;
a second contact vessel gas outlet; and
a second contact vessel liquid outlet.

69-83. (canceled)
